(19) United States
(12) Patent Application Publication
(10) Pub. No.: US 2011/0167758 A1
(43) Pub. Date: Jul. 14, 2011

(54) NODE MODULE FOR A SIMPLIFIED, INTERCONNECTING CELLULAR CONSTRUCTION SYSTEM

(76) Inventor: IYAD MOHAMAD ADNAN DAADOUSH, Damascus (SY)

(21) Appl. No.: 13/004,859

(22) Filed: Jan. 11, 2011

Related U.S. Application Data
(63) Continuation-in-part of application No. PCT/IB2009/006123, filed on Jun. 30, 2009.

(30) Foreign Application Priority Data
Jul. 3, 2008 (AE) 6942008
Feb. 3, 2009 (IB) PCT/IB2009/000177

(51) Int. Cl. E04B 1/38; E04B 1/19; F16B 17/00

(52) U.S. Cl. 52/745.21; 403/345

(57) ABSTRACT

The teachings are generally directed to a construction system that includes a load-bearing, node module for simplifying the connection of a series of load-bearing bars during the construction of a building or non-building structure. The load-bearing bars can be used to form load-bearing cells that can provide structural support, as well as modularity, in the construction of a building or non-building structure. The teachings provide (i) an ability to save on the complexities and amounts of materials, equipment, and labor needed in a construction project, (ii) a reduction in costs, and (iii) a novel, simplified, and bid-winning approach to the art of construction.

### CROSS-REFERENCE TO RELATED APPLICATIONS

This application is a continuation-in-part of International Patent Application No. PCT/IB2009/006123, filed Jun. 30, 2009, which claims the benefit of International Patent Application No. PCT/IB2009/000177, filed Feb. 3, 2009, and AE Application No. 694/2008, filed Jul. 13, 2008; each of which is hereby incorporated herein by reference in its entirety.

### BACKGROUND

1. Field of the Teachings

The teachings are directed to a construction system that includes a load-bearing, node module for simplifying the connection of a series of load-bearing bars during the construction of a building or non-building structure, and the load-bearing bars can be used to form three-dimensional frame structures.

2. Description of the Related Art

The art of construction is old. Existing systems for the construction of a building or non-building structure divide the structure into a number of elements, such as columns, beams and slabs connected together. These divisions are considered as the basic elements of the structure being constructed and are the status-quo that has been long-accepted.

Unfortunately, the art of construction carries many downfalls in the status-quo, downfalls that are now built into the long-accepted construction infrastructure. These downfalls include, for example, (i) the complexities of design that result in increased time and budget requirements, and (ii) the amounts of materials, equipment, and labor that need to be involved in a construction project. As such, the status-quo brings in extra time requirements, labor requirements, manufacturing requirements, material waste, and, bottom line, exorbitant costs. Accordingly, one of skill will appreciate a reduction in costs, both financial and environmental. As such, a structure that can be connected using limited material, time, and personnel, would be appreciated.

The teachings provided herein offer one of skill (i) an ability to save on the complexities and amounts of materials, equipment, and labor needed in a construction project, (ii) a reduction in costs, and (iii) a novel, simplified, and bid-winning approach to the art of construction.

### SUMMARY

The teachings are generally directed to a construction system that includes a load-bearing, node module for simplifying the connection of a series of load-bearing bars during the construction of a building or non-building structure. The load-bearing bars can be used to form cells, such as three-dimensional frame structures, that provide structural support for a building or non-building structure. In some embodiments, the node module comprises a support structure having a top surface and a bottom surface; and, a plurality of bar connectors. In these embodiments, the plurality of bar connectors can include at least one pair of bar connectors, each pair configured to direct (i) an opposing axial load into the support structure, the opposing axial load comprising a first load on the top surface that is opposed to a second load on the bottom surface; and, (ii) an opposing shear load that is orthogonal to the opposing axial load between each of the at least one pair through the support structure, the opposing shear load comprising a tensile force and a compression force on the support structure. Each bar connector is configured to mate with a respective, complementary portion of a bar, the mating of each of the bar connectors with their respective bars forming a node module configured to bear the opposing axial load and the opposing shear load within the building or non-building structure.

In some embodiments, the top surface and the opposing bottom surface of the support structure have a compressive strength that is at least as high as a highest expected axial load in a location of intended use within the building; and, the connection between each respective bar and the node module has a shear strength that is at least as high as a highest expected load that is orthogonal to the axial load in the location of intended use within the building.

The node modules taught herein can have one or more connectors for connecting the node module to a bar. In some embodiments, the node module can comprise a pair of connectors within the at least one pair of bar connectors that shares a central axis, or it can comprise a pair of connectors that do not share a central axis. The node module can be used as a component in a shell support structure or a core support structure. And, in some embodiments, the mating of each of the bar connectors with their respective bars comprises a releasable, slidable connection.

In some embodiments, the support structure comprises a horizontal base plate with at least one pair of bar connectors and a vertical plate, the vertical plate forming a plane that intersects a plane formed by the horizontal plate and separating the at least one pair of bar connectors. The node module can comprise a cast metal alloy and, in some embodiments, the node module can include an elastic coating, for example, where the node module contacts a bar.

The support structure can comprise a first plate having the at least one pair of bar connectors and a second plate forming a plane that intersects a plane formed by the first plate at an angle θ, the second plate separating the at least one pair of bar connectors. The angle θ, for example, can comprise an angle of incline upon which the building or non-building structure is constructed. In some embodiments, the angle θ can comprise an angle of assembly formed by a stacking of cellular bar modules within the building or non-building structure.

The teachings are also directed to a system comprising at least two vertical load-bearing bars and a node module as described herein. In some embodiments, the load-bearing, node module is used for simplifying the connection of a series of load-bearing bars during the construction of a building or non-building structure. In these embodiments, the node module comprises a first plate comprising a top surface, a bottom surface, and a base for a plurality of bar connectors. The first plate forms a first plane, and, a second plate forms a second plane that intersects the first plane at an angle θ, the second plate separating the at least one pair of bar connectors. The plurality of bar connectors can include at least one pair of bar connectors configured to direct (i) an opposing axial load into the first plate, the opposing axial load comprising a first axial load on the top surface that is opposed to a second axial load on the bottom surface; and, (ii) an opposing shear load that is orthogonal to the opposing axial load between each of the at least one pair of connectors through the first plate, the opposing shear load comprising a tensile force and a compression force on the first plate. In the present teachings, a load can include, for example, a dead load, a live load, an environmental load, or a combination thereof.

Each bar connector can be configured to mate with a respective, complementary portion of a bar, the mating of each of the bar connectors with their respective bars through the node module configured to bear an axial load and a shear load orthogonal to the axial load within the building. The mating can comprise a releasable, slidable connection, the top surface and the opposing bottom surface of the support structure can have a compressive strength that is at least as high as a highest expected axial load in a location of intended use within the building; and, the connection between each respective bar and the node module can have a shear strength that is at least as high as a highest expected shear load orthogonal to the axial load in the location of intended use within the building.

The teachings are also directed to a cellular construction system for constructing a building or non-building structure. The system can comprise a node module as described herein; a first cell having a first three-dimensional frame structure comprising a first axial load bearing bar having a first respective complementary portion for mating with a first connector of the node module; and, a second cell having a second three-dimensional frame structure comprising a second axial load bearing bar having a second respective complementary portion for mating with a second connector of the node module. The node module can connect the first three-dimensional frame structure to the second three-dimensional frame structure in the creation of a cellular building structure or a cellular non-building structure.

The dimensions of the first or second cellular, three-dimensional frame structure can exceeds size standards set for transporting construction materials to a construction site as compared to pre-fabricated cellular structures that are required to follow the size standards.

In some embodiments, the node module connects the first three-dimensional geometrical frame structure to the second three-dimensional geometrical frame structure in a face-to-face, edge-to-edge, or vertex-to-vertex arrangement in the creation of a cellular building structure.

The teachings are also directed to a method of creating a cellular building structure. The method comprises obtaining a node module described herein, constructing a first cell having a first three-dimensional frame structure comprising a first axial load bearing bar having a first respective complementary portion for mating with a first connector of the node module, constructing a second cell having a second three-dimensional frame structure comprising a second axial load bearing bar having a second respective complementary portion for mating with a second connector of the node module, and interconnecting the first three-dimensional geometrical frame structure to the second three-dimensional geometrical frame structure using the node module in the creation of the cellular building structure. The interconnecting can include (i) mating the first connector of the node module to the first respective complementary portion and (ii) mating the second connector of the node module to the second respective complementary portion.

The teachings are also directed to a cellular construction system comprising a single-unit, node module. The single-unit, node module can be configured with a means for interconnecting a series of structural, three-dimensional load-bearing cells, the series including a first cell and a second cell. The first cell can comprise a first axial load bearing bar having a first respective complementary portion for mating with a first connector of the node module. The second cell can comprise a second axial load bearing bar having a second respective complementary portion for mating with a second connector of the node module. The node module can connect the first cell to the second cell using a process that includes (i) mating the first connector of the node module to the first respective complementary portion and (ii) mating the second connector of the node module to the second respective complementary portion, such that the first cell and the second cell are connected in a face-to-face, edge to edge, or vertex to vertex arrangement in the creation of a cellular building or non-building structure.

The teachings are also directed to a three-dimensional, load-bearing cell for use in a cellular construction system for a building or non-building structure. The cell comprises a vertical-load-bearing bar; and, a horizontal-load-bearing bar attached to the vertical-load-bearing bar. The load-bearing cell can be constructed on-site and can have a dimension that exceeds size standards set for transporting construction materials to a construction site as compared to pre-fabricated cellular structures, which one of skill will (i) readily distinguish from existing “pre-fabricated structural units” or “pre-fabricated structural modules” that have been designed to a size limit that complies with such industry standards; and (ii) readily see as a valuable and innovative technical contribution. The load-bearing cell can also be configured to attach to a second cell using a cell-to-cell connector, the load-bearing cell and the second cell being connected through the cell-to-cell connector in a face-to-face, edge to edge, or vertex to vertex arrangement in the cellular construction of the building or non-building structure.

The load-bearing cell can be used as a shell support structure or a core support structure and, in some embodiments, can be composed of prefabricated assembly components that are readily transportable to the site. Moreover, the load-bearing cell can be more readily assembled and interconnected within the building or non-building structure when compared to non-cellular load-bearing structures that are otherwise used for the shell support structure or the core support structure of the building or non-building structure.

In some embodiments, the load-bearing cell can have an internal cross-bracing across the inner volume of the cell that functions to subdivide load-induced stresses into smaller distributed force components. And, in some embodiments, the load-bearing cell can have a vertical load-bearing bar with a fitting that is complementary to the cell-to-cell connector. In these embodiments, the cell-to-cell connector can be a single-unit node having at least one pair of connectors for connecting the load-bearing cell to the second cell.

In some embodiments, the cell-to-cell connector can comprise a first plate having the at least one pair of bar connectors and a second plate forming a plane that intersects a plane formed by the first plate at an angle θ ranging from about 0 degrees to about 45 degrees. The second plate can be positioned between at least two pair of bar connectors on the first plate, each pair of bar connectors having a first connector on a first side of the first plate and a second connector on a second side of the first plate, the first side opposing the second side.

In some embodiments, the angle θ can comprise an angle of incline that ranges from greater than 0 degrees to about 45 degrees upon which the building or non-building structure is constructed on a support surface. In some embodiments, the angle θ can comprise an angle of assembly formed by a stacking of load-bearing cells within the building or non-building structure.

The teachings are also directed to a frame structure system. The system can comprise a series of inter-connected, modular three dimensional geometrical frame structures connected in a face-to-face arrangement, each individual frame structure comprising a series of bars connected to define faces of a three dimensional geometrical frame structure that includes a base face; and, at least one bar forming a bracing for a face of the geometrical frame structure. The geometrical frame structure can comprise a plurality of bars that form a cross-bracing for the base face.

In some embodiments, the geometrical frame structure can comprise bars forming a triangular frame structure within a vertical face of the geometrical frame structure, the triangular frame structure positioned within the upper part of the face; one or more diagonal bars to cross-brace vertical faces of the frame; or one or more diagonal bars extending across the interior of the frame. In some embodiments, a geometrical frame structure can comprise at least 6 bars and, in some embodiments, a geometrical frame structure can comprise cuboid frame structures formed from 14 bars, having twelve bars forming the edges of the cuboid frame structure, and two bars forming a cross-bracing for a base face.

In some embodiments, the frame structure system can comprise a means for interconnecting the geometrical frame structures in a face-to-face, vertex-to-vertex, or edge-to-edge configuration, or a means for connecting a structure to a base surface. And, in some embodiments, the geometrical frame structures can be connected side-by-side and/or stacked, for example, on top of each other. In these embodiments the structures can be used to form a core support structure or a shell support structure for a building or non-building structure.

The teachings are also directed to a method of constructing the frame structure system. The method comprises delivering a plurality of pre-formed load-bearing bars to a construction site, in which each bar in the plurality of load-bearing bars can have a dimension that was preselected for forming the geometrical frame structure without further resizing of the load-bearing bar. The method also comprises forming the geometrical frame structures on-site.

The teachings are also directed to an apparatus for transporting and constructing the frame structure system. The apparatus includes a container for transporting pre-selected bars used in forming the geometrical frame, a frame structure configured for receiving the pre-selected bars from the containers and holding the pre-selected bars in a desired position to define the faces of the geometrical frame, and a configuration to facilitate connecting, for example welding, the bars to form the geometrical frame structure. A building or non-building structure can comprise the frame structure system, in some embodiments.

### BRIEF DESCRIPTION OF THE FIGURES

FIG. 1 shows a birds eye aspect of a cubical frame, according to some embodiments.

FIG. 2 shows a side aspect of a cubical frame, according to some embodiments.

FIG. 3 shows a three dimensional aspect of a cubical frame, according to some embodiments.

FIG. 4 shows an expanded view of the corner piece of a cubical frame, according to some embodiments.

FIG. 5 shows a birds eye aspect of cubical frames arranged into a modular system, according to some embodiments.

FIG. 6 shows a side aspect of cubical frames arranged into a modular system, according to some embodiments.

FIG. 7 shows a three dimensional aspect of cubical frames arranged into a modular system, according to some embodiments.

FIG. 8 shows an expanded view of the columns and beams which are produced from inter-connecting cubical frames, according to some embodiments.

FIG. 9 shows a birds eye aspect of a node module, according to some embodiments.

FIG. 10 shows a side aspect of a node module, according to some embodiments.

FIG. 11 shows a three dimensional aspect of a node module, according to some embodiments.

FIG. 12 shows a node module being inserted into the connection point of 4 cubical frames, according to some embodiments.

FIG. 13 shows a base node module inserted into the connection point of two cubical frames, according to some embodiments.

FIG. 14 shows a three dimensional aspect of cubical frames arranged into a modular system with flooring, according to some embodiments.

FIG. 15 shows a cubical frame structure installation machine, according to some embodiments.

FIG. 16 shows a cubical frame structure installation machine with cubical frame structure bars being connected, according to some embodiments.

FIGS. 17-26 show the three dimensional aspects of geometrical frames, according to some embodiments.

FIG. 27 shows a three dimensional aspect of four sided oblique prism frame structures arranged into a modular system, according to some embodiments.

FIG. 28 shows a three dimensional aspect of geometrical frames arranged into a modular system, according to some embodiments.

FIG. 29 shows a bird's eye aspect of FIG. 28, showing geometrical frames arranged into a modular system, according to some embodiments.

FIGS. 30-33 show three dimensional aspects of node modules, according to some embodiments.

FIGS. 34 and 35 show three dimensional aspects of plate modules, according to some embodiments.

FIG. 36 shows the three dimensional aspects of cuboid frame structures and arranged into a modular system and connected together with plate modules, node modules and brackets, according to some embodiments.

FIG. 37 shows a geometrical frame structural installation machine, according to some embodiments.

FIG. 38 shows a geometrical frame structural installation machine with frame structure bars being connected to form a geometrical frame structure, according to some embodiments.

FIG. 39 illustrates a load-bearing node module which can be used as a connection means, and which can be inclined at a desired angle, according to some embodiments.

FIG. 40 illustrates a clip module that can be used as a connection means, according to some embodiments.

FIG. 41 illustrates a node-to-node arrangement that includes a series of interconnected triangular prisms, according to some embodiments.

FIG. 42 illustrates the flexibility in interconnecting and stacking that is provided herein, according to some embodiments.

FIGS. 43A₁₋₅-G₁₋₅ provides a variety of bracing designs contemplated, according to some embodiments.

FIG. 44 illustrates an example of a cell that is built as an inclined cell, where the node module has an angle θ greater than 0, according to some embodiments.

FIG. 45 illustrates a side-aspect sketch of an inclined building structure, where the structure includes inclined cells and inclined node modules, according to some embodiments.

FIG. 46 illustrates the construction of a building or non-building structure having the cells as cantilever units, according to some embodiments.

FIG. 47 illustrates cells placed in face-to-face arrangements and stacked in an axial/radial grid-type configuration, according to some embodiments.

### DETAILED DESCRIPTION OF THE TEACHINGS HEREIN

The teachings are generally directed to a construction system that includes a load-bearing, node module for simplifying the connection of a series of load-bearing bars during the construction of a building or non-building structure.

It should be appreciated that a “building” structure can refer to, for example, any human-made structure used or intended for supporting or sheltering any use or continuous occupancy. A “non-building” structure can refer to, for example, structures that are not designed for human occupancy and is used by those of skill to distinctly identify structures that are not “building” structures. Examples of non-building structures can include aerial lift pylons; boat lifts; bridges and bridge like structures, such as aqueducts, overpasses, trestles, viaducts, and the like; building canopies; chimneys and smokestacks; dams; electric power transmission towers; ferris wheels and observation wheels; monuments; parking structures; offshore oil platforms; piers; roller coasters; retaining walls; sewers; cranes; automobiles; structures designed to support, contain, or convey liquid or gaseous matter, including cooling towers, pipelines, distillation equipment and structural supports at chemical and petrochemical plants and oil refineries, and storage tanks; television and radio masts and towers; tunnels; and, wharves; to name just a few. One of skill will appreciate that the teachings provided herein are for example only, and that there are a plethora of applications of these general teachings.

The load-bearing bars can be used to form cells, such as three-dimensional frame structures, that provide structural support for a building or non-building structure. The cells can be interconnected by the node modules. In some embodiments, the “cells” can be referred to interchangeably using other terms in the teachings provided herein, such as “frame structures,” “geometrical frame structures, three-dimensional geometrical frame structures, geometrical frames, and the like, and the terms “three-dimensional,” “modular” or “non-modular” can often sometimes be used to modify the terms for one or more particular applications of the teachings provided herein. Likewise, the term “bars” can be used to refer to any load-bearing frame component, such as a “beam,” or a “column,” in some embodiments. In some embodiments, the teachings provided herein can sometimes include non-load-bearing frame components as well, and such components can also include “bars.” One of skill will recognize that a non-load-bearing frame component can refer to a component that will occasional bear a load due to, for example, a live load or an environment load in some embodiments.

The teachings are also directed to a system comprising at least two axial load-bearing bars and a node module as described herein. The axial load includes, for example, a load that is taken by the axis of a bar. The axial load, for example, can be a vertical load, a horizontal load, or it can be a component of a vertical or horizontal load. One of skill will appreciate that loads placed on a building or non-building structure into three basic force components, X, Y, and Z. These three basic components can be used to define virtually any load placed on the building or non-building structure in three dimensional space using, for example, the force components denoted by X cos θ, X sin θ, Y cos θ, Y sin θ, Z cos θ, and Z sin θ, where θ can be used to define the angle of the component force, for example, from the X, Y, or Z directions. These loads, for example, can be derived from a dead load, a live load, an environmental load, or a combination thereof. One of skill will appreciated that, in some embodiments, the dead load includes gravitational stresses, the live load includes variable stresses that are due to persons, for example, in a building structure, and the environmental load includes wind, rain, earthquakes, flood, mechanical impacts, and the like. Given the general teachings provided herein, the knowledge of one of skill can be used to select and engineer the materials and methods taught herein to be suitable for a desired construction.

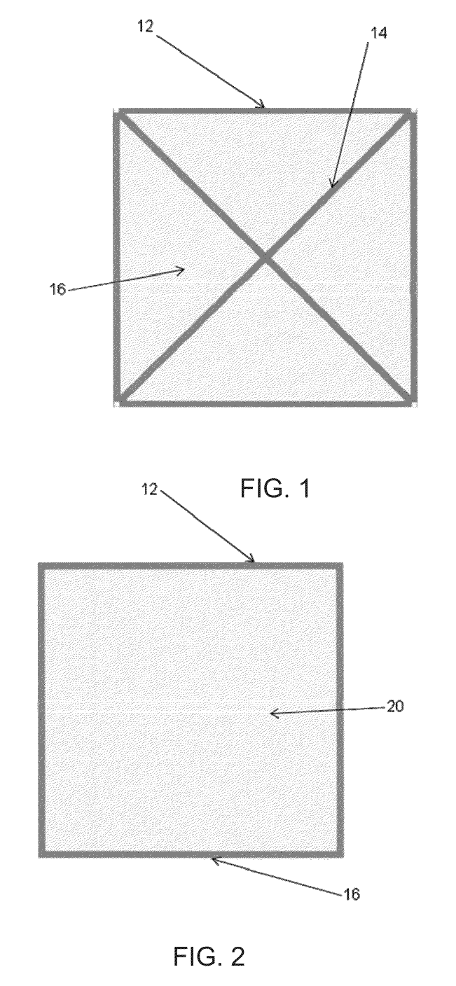

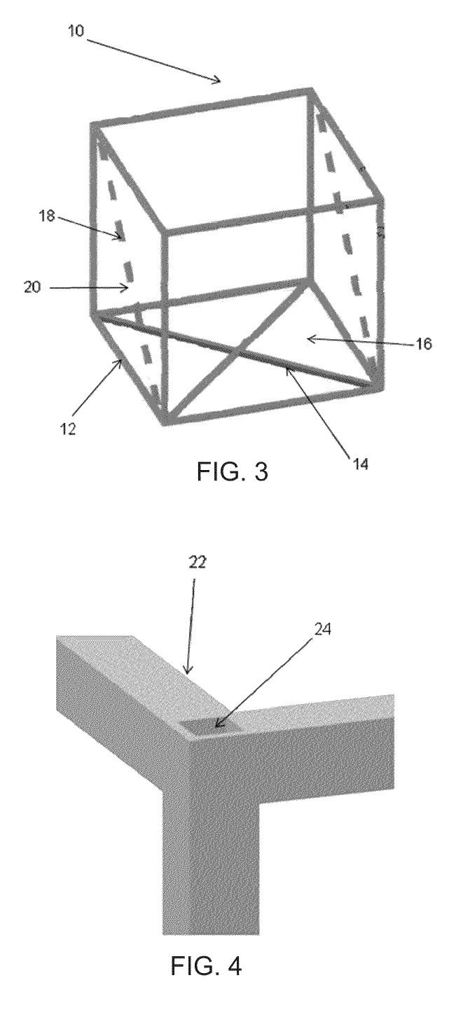

FIGS. 1-3 show various aspects of a cubical frame structure 10 that is connectable to form a frame structure system, according to some embodiments. The cubical frame structure 10 can be constructed from twelve bars 12, corresponding to the twelve edges found on a cube. These bars can be connected to define the faces of a cubical frame structure 10. One or more further bars 14 can be arranged diagonally to form a cross bracing on the lower plane (or lower face) 16 of the cubical frame 10. In some embodiments, the basic cuboid structure can be formed from a total of fourteen bars 12, twelve of the fourteen bars making up the twelve edges and a remaining two bars 14 forming a cross bracing on the lower plane 16. Diagonal bars 18 may also be incorporated on the vertical planes (or vertical faces) 20 of the cubical frame 10 to counteract horizontal forces. Such a design can be used to buttress, for example, cubical frames that are incorporated at the bottom of a modular system where horizontal forces are greater. Adding diagonal bars 18 to counteract horizontal force may also be recommended where the cubical frames are to be used in a modular system carrying large structural spans, bearing cantilevers, or forming space frame structures.

The bars 12, 14 may be constructed from any suitable material known to one of skill. In some embodiments, the material can include any form of steel that is strong enough to withstand at least the highest expected axial load in the location where the bar is used in a building or non-building structure. One of skill will also appreciate that the bar can be pre-formed to any desired shape, as long as the interconnectability taught herein can be implemented by such desired shape. As such, the cross sectional form of the bars may be any desired form that is suitable and provides the necessary strength. In some embodiments, the desired form may be one that is lightweight, an example being a cylindrical cross-section in the form of a square, a circle, or an ellipse; or, in some embodiments, an I-beam type of structure.

The cubical frames 10 may vary in size, corresponding to the length of the bars 12. The individual cubical frames 10 may vary in dimensions, and each bar in the cubical frame may or may not be of the same size and form. In some embodiments, the frame structures 10 can be of a standard size such as, for example, a size that works well in a simple, modular system. In addition, in some embodiments, each bar may be of the same size in a frame structure, further simplifying the selection, transportation, and construction process. Having standard sizes can also help to ensure that the individual cubical frames are correctly aligned and capable of interconnecting in any such construction system.

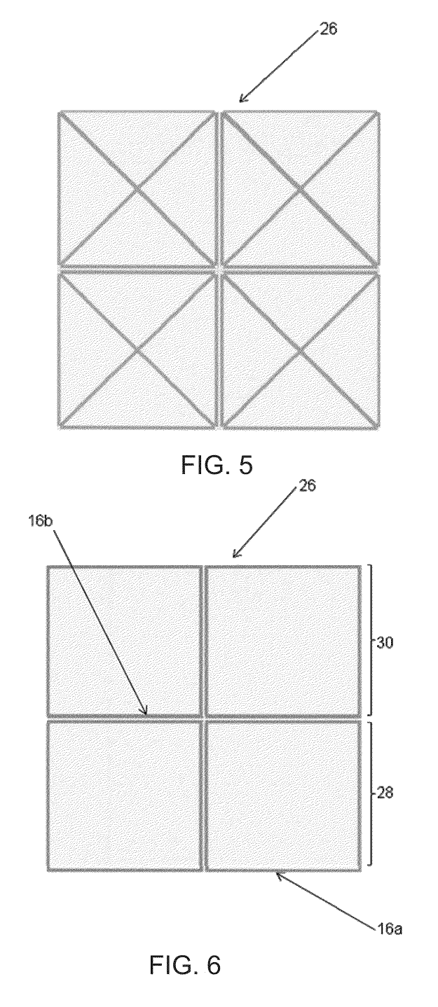

FIG. 4 shows an expanded view of a corner piece 22 of a cubical frame 10, according to some embodiments. A socket 24 can be provided that is capable of accepting one of the four pins on the node module thereby permitting the cubical frame to be attached to others in the modular system. Such sockets 24 may be incorporated in all eight corner pieces 22, for example, and permit any individual cubical frame to be attachable to others in all three dimensions.

Two or more cubical frames 10 may be inter-connected in a face-to-face arrangement in a modular system which may act as infrastructure for the construction of a building. The teachings herein provides cubical frame structures 10 which are connectable side-by-side and/or on top of each other to form a three dimensional arrangement of cubical frames structures. The teachings herein further provide a method of forming a modular system; pre-formed bars 12 can be delivered to a site for installation and are connected to define the frame structures 10, which can be further connectable, for example, to form a modular or non-modular system.

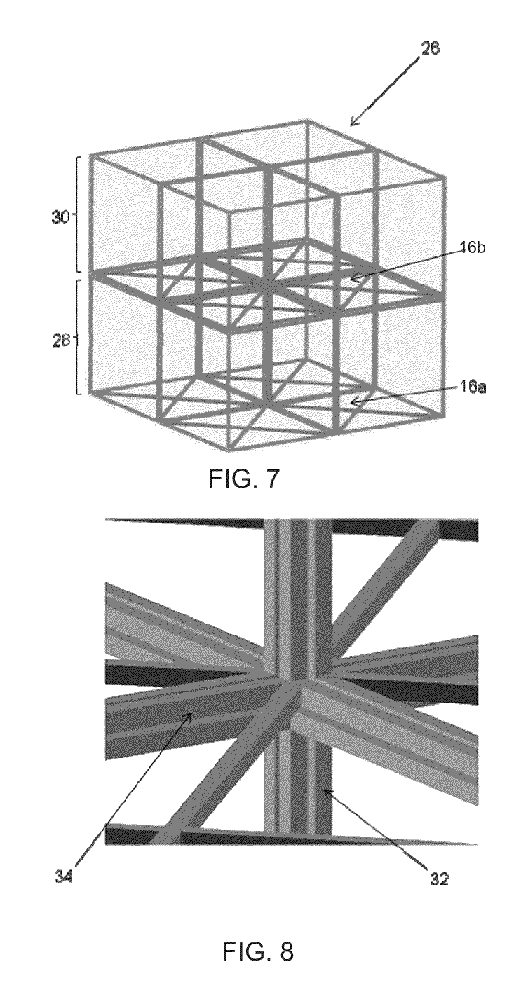

FIGS. 5 to 7 show various aspects of cubical frames 10 arranged into a modular system 26, according to some embodiments. In FIGS. 5 to 7, eight cubical frames 10 have been connected. One or more cubical frames can be used to form the lower layer 28, and form the structure of a ground floor, for example. These can be attached via the base node modules to a solid base or foundations on the same level, as described herein. The node modules 36, 40 help ensure that the individual cubical frames 10 are correctly aligned both vertically and horizontally. The node modules can further be used to help ensure that the weight of the load is transferred directly down through the structure to the solid base. The bars of the cubical frames can be further fastened together in the same frame, for example, with brackets 105 as described in other FIGs, or secondary sub-bars, to provide a stronger frame structure. The node modules, the cubical frames, and the solid base, can be further fastened together, in some embodiments, with bolts, to provide a stronger interconnected structure.

The solid base can have a flat surface to ensure the correct alignment of the cubical frames 10 and further help ensure that the floors placed on upper levels are also flat. Another layer 30 of cubical frames 10 may be connected to the lower layer 28 to form a first floor and so on until the desired number of floors has been added.

One or more pre-cast slabs, can be laid upon the lower surface 16a, 16b of the cubical frames to provide a floor. Moreover, in some embodiments, the vertical faces and partitions which help to form the internal and external walls can be constructed from lightweight panels.

FIG. 8 shows an expanded view of the columns 32 and beams 34 which can be produced from inter-connecting structural frames with a node module, according to some embodiments. The columns 32 and beams 34 can be used to interconnect structural frames using a connector, such as a node module.

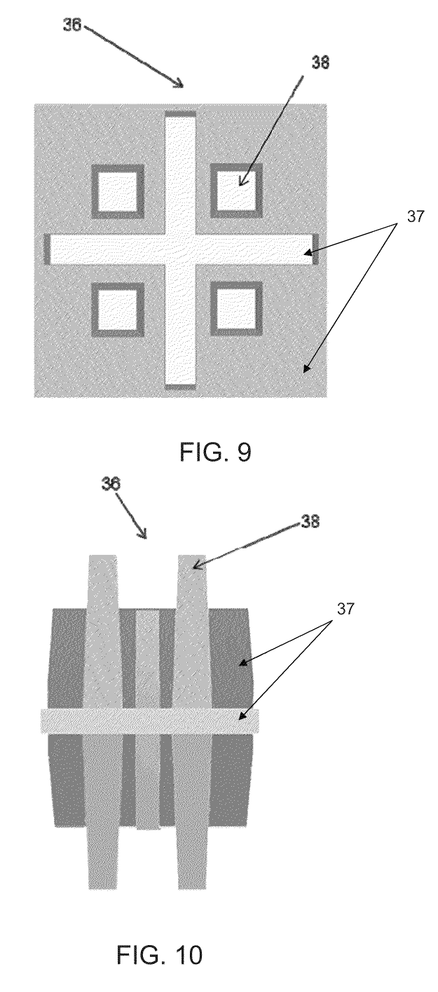

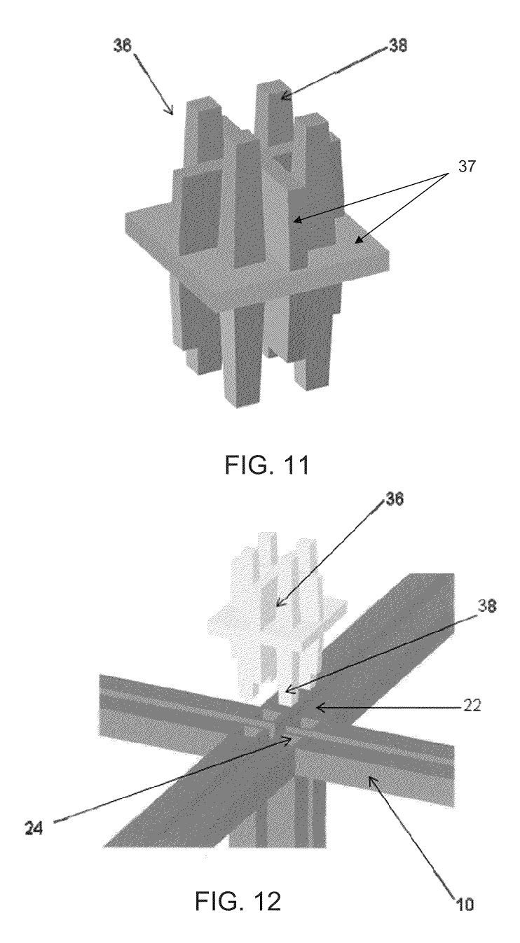

FIGS. 9-11 show various aspects of a node module, according to some embodiments. The node module 36 can comprise plates 37 and pins 38 that are complementary with sockets 24 found in the frame structures 10, for example, in the corner pieces 22.

FIG. 12 shows a node module being inserted into the junction of the corner pieces of four cubical frames, according to some embodiments. Each of the four lower pins 38 can be inserted, one each, into a corner piece socket 24. Up to eight cubical frames 10, for example, may converge on a single point. The node module 36 can provide eight pins 38, for example, four pointing downwards and four pointing upwards, thereby permitting these eight cubical frames 10 to be connected at a single point.

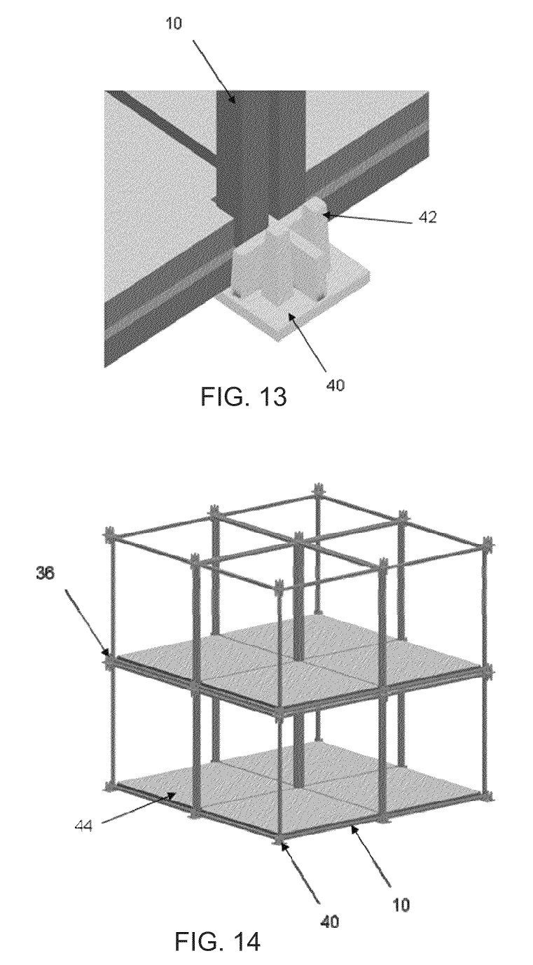

FIGS. 13 and 14 show base node module inserted into the junctions of the lower corner pieces of cubical frames that can form the base of the lower layer of the structure, according to some embodiments. The base node module 40 comprises pins 42 complementary with the sockets found in the cubical frames corner pieces. Up to four cubical frames 10, for example, may converge on a single point on the base of the structure. The base node module 40 can be used to provide four pins 42 extending upwards from a flat base, thereby permitting these four cubical frames to be connected at a single point. In some embodiments, one or more pre-cast slabs 44 can be laid upon the lower surface to form a floor.

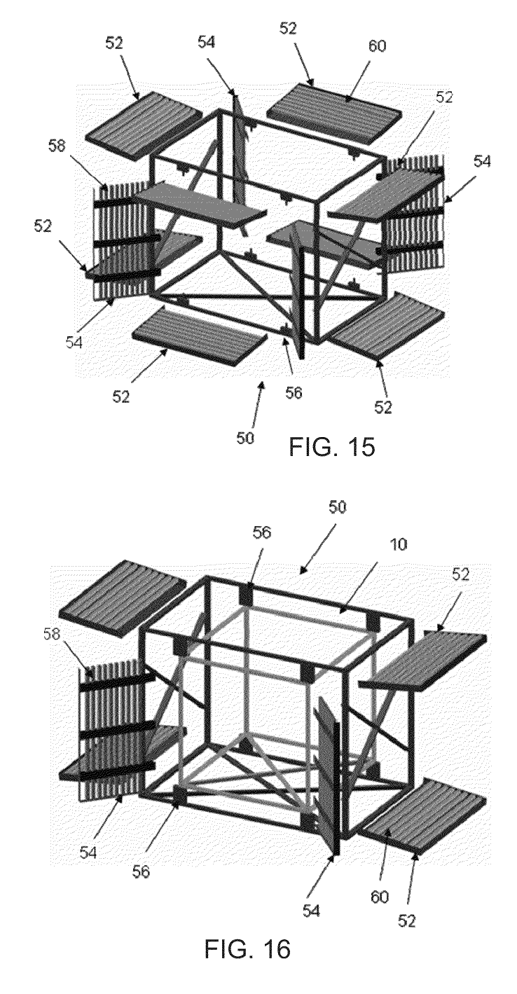

FIGS. 15 and 16 show an installation machine for use in forming a cubical frame structure, according to some embodiments. The cubical frame structure machine 50 arranges the pre-formed bars 12 into the correct position, and connects and welds the pre-formed bars 12 together to form the cubical frame structure 10. The machine can be transported to, and installed at, the construction site, such that a production line to produce the cubical frame structures can be established in the factory or, in some embodiments, directly at the site of construction to build frame structures that may exceed the sizes that can be transported at all, safely, or as a matter of law. The installation machine can be transported by either land, sea, or air to the site of construction. It can be transported, in some embodiments, as a one-piece apparatus using any transportation means, for example, by helicopter or crane. The machine can comprise containers 52, 54 containing either horizontal or vertical pre-formed bars. The containers 52, 54 can be fixed on the frame structure of the machine with connections to eight automatically moveable fins 56. The fins 56 can be used to hold the pre-formed bars in a desired position to define the faces of the desired frame structure. Vertical pre-formed bars 58 can be installed automatically onto fins from the vertical pre-formed bars containers 54 and horizontal bars 60 can be installed automatically onto the fins 56 from the horizontal pre-formed bars containers 52. Once the bars are installed in the structure, all the bars can be connected to form a desired three-dimensional frame structure. In some embodiments, the bars can be welded to form the cubical frame structure 10. The formed structure 10 can then be removed from the machine 50, at which time it is ready for testing and connecting into a modular or non-modular building or non-building structure.

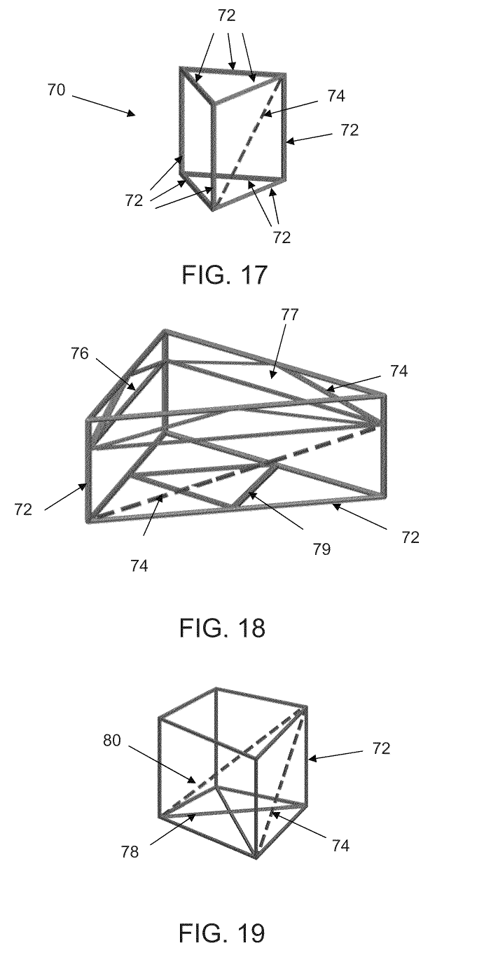

One of skill will appreciate that there are a plethora of frame structure shapes possible for use with the teachings provided herein. FIGS. 17-25 show various geometrical frame structures, according to some embodiments.

FIGS. 17 and 18 show different triangular prism frame structures, according to some embodiments. The triangular prism frame structures 70 can be constructed from nine bars 72 corresponding to the nine edges found on a triangular prism to define the faces of the triangular frame structure. Additional diagonal bars 74 and horizontal bars 76 can be incorporated on the top portion of the triangular prism vertical faces forming a vertical triangular frame 77 within the vertical face. The triangular frame 77 can help support the middle point of the bars forming the top face of the triangular prism frame. Further bracing bars 79, connecting the middle points of the bars forming the base face, can be arranged as cross-bracing across the lower plane.

FIGS. 19, 20, and 22 show how diagonal bars may be used to add structural strength, according to some embodiments. Diagonal bars 74,80 may be incorporated, for example, across the interior of the frame structure from an upper corner of the frame to a lower corner to provide further strength to the frame structure.

FIGS. 24 and 25 show how bar length can be varied, according to some embodiments. By varying the length of the vertical bars 72 a desired sloping upper plane for the frame structure can be formed. Pre-formed bars 82 may be bent, such that the face 83 of the frame structure is non-planar.

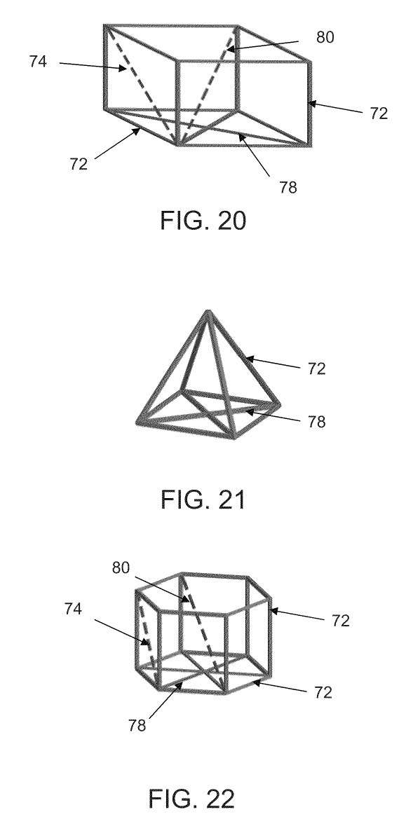

FIGS. 19 and 20 show frame structures constructed from twelve bars corresponding to the twelve edges found on a quadrilateral prism to define the faces of the quadrilateral prism frame structure, according to some embodiments. Two cross bracing bars 78 can be used in the formation of a base, for example.

FIG. 21 shows a four sided pyramidal shaped frame structure, where the frame structures are constructed from eight bars, according to some embodiments. Again, cross-bracing bars 78 can be used in the formation of a base.

FIG. 22 shows how a hexagonal prism frame structures can be constructed from eighteen bars, according to some embodiments. Cross-bracing bars 78 can again be used, for example, in the formation of the lower face, and bars 74, 80 in the vertical planes may also be used.

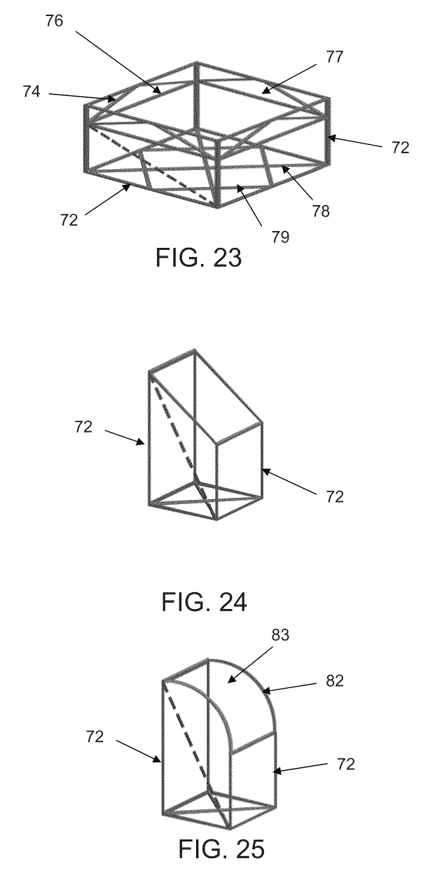

FIG. 23 shows a cuboid frame structure constructed from twelve bars, according to some embodiments. Horizontal 76 and diagonal 74 bars can be used in the vertical faces forming vertical triangular frames 77 in an effort to help support the middle of a bar that defines the top face of the structure. Cross-bracing bars 78 and the bracing bars 79 can be used for connecting the middle points of the bars in the lower face.

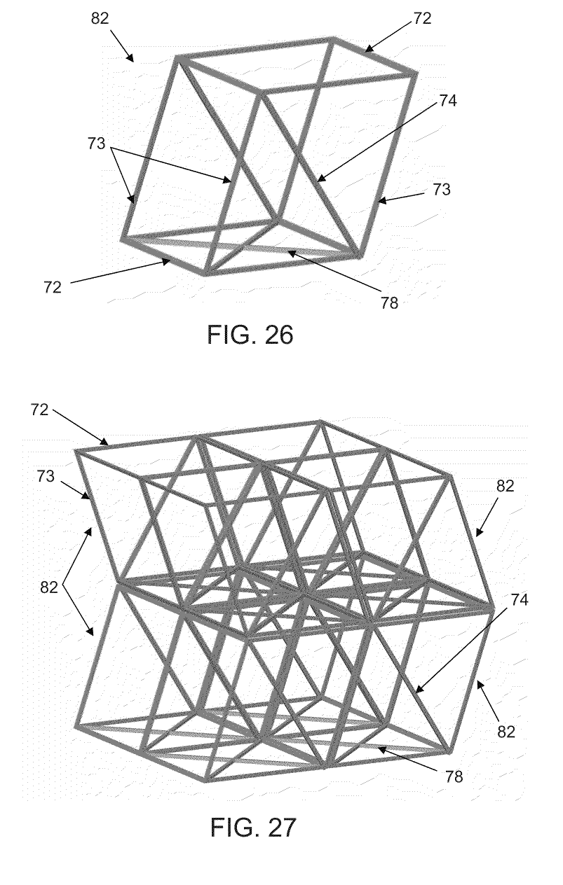

FIGS. 26 and 27 show an oblique-sided cuboidal frame structure, according to some embodiments. Diagonal cross-bracing bars 74 can be used in the vertical faces. The frame structure can be constructed from twelve bars 72, 73 corresponding to the twelve edges found on a oblique four sided prism to define the faces of the oblique four sided prism frame structure 82. The structure can include two diagonal bars cross-bracing the vertical faces 74 and two cross-bracing bars 78 on its base.

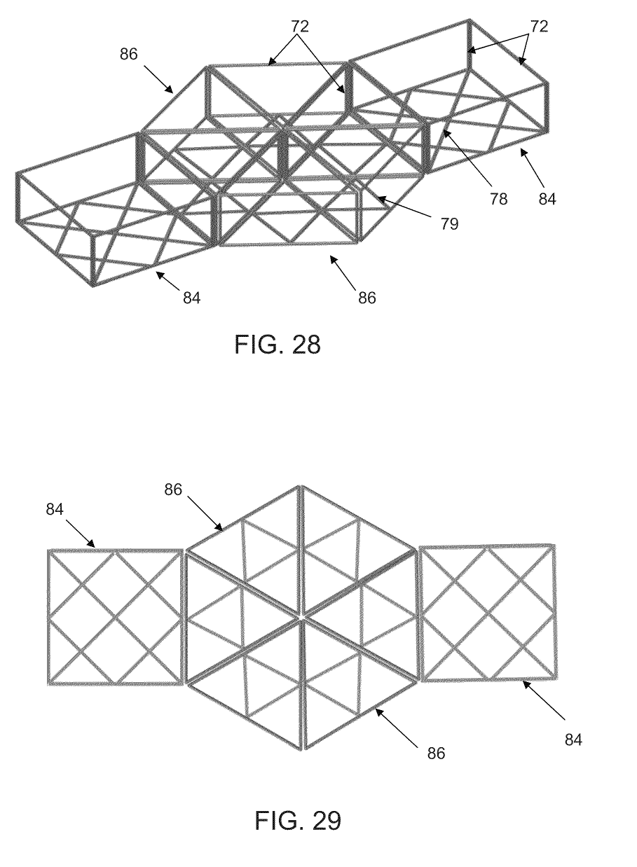

FIGS. 27-29 show an examples of a more complicated structure, according to some embodiments. The structure can be formed, for example, from inter-connected oblique four sided prism frame structures 82. The modular frame structure system as shown in FIGS. 28 and 29 is constructed from cuboid frame structures 84 and triangular prism frame structures 86.

The teachings provided herein also focus on the novelty and applicability of the node module itself. The node module provides excellent added utility to any such construction system, for at least the reason that it facilitates a simplification of the complexity of components, a substantial reduction in types and quantities of materials, a substantial reduction in time, and a substantial reduction in labor required to construct a building or non-building structure. These features are in addition to the “green” aspect of the conservation of resources through an initial use of less materials, as well as making it easier to disassemble and re-use materials.

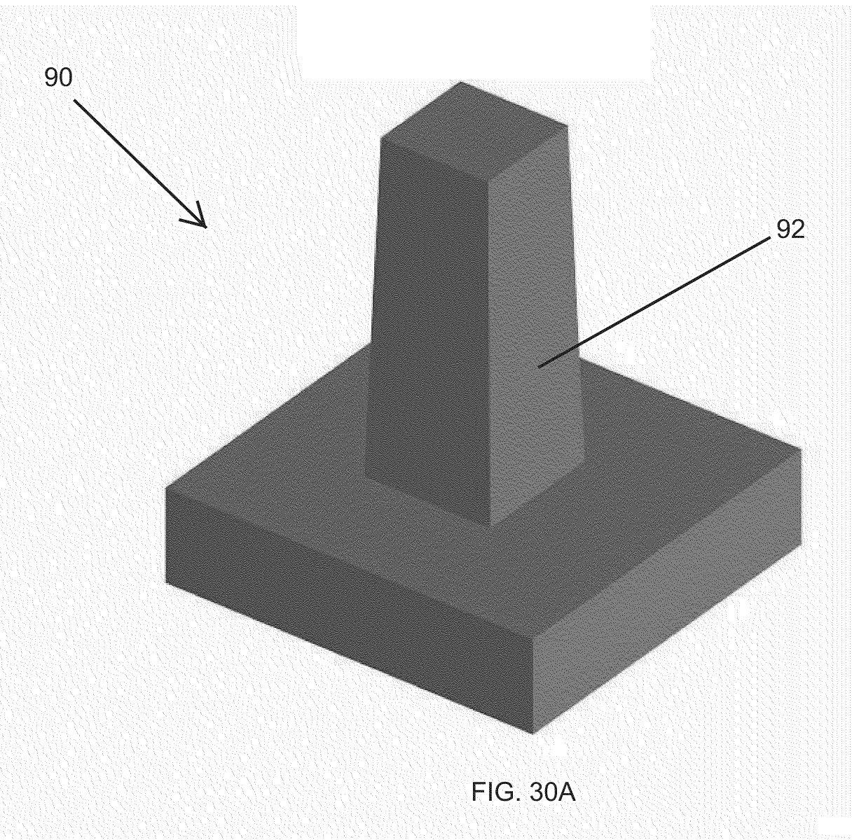

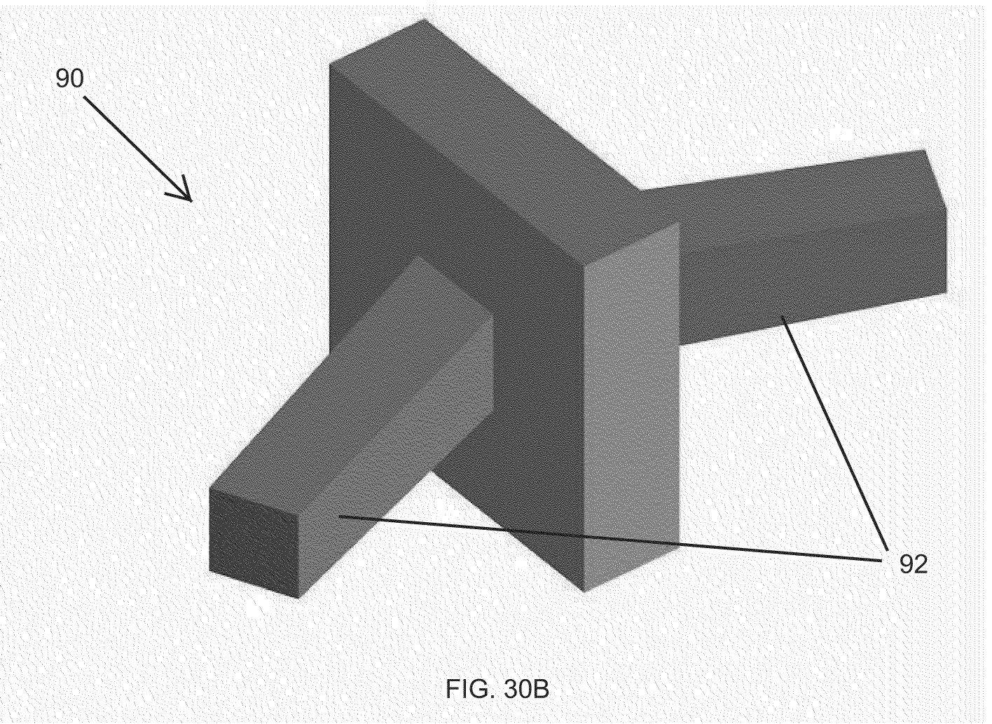

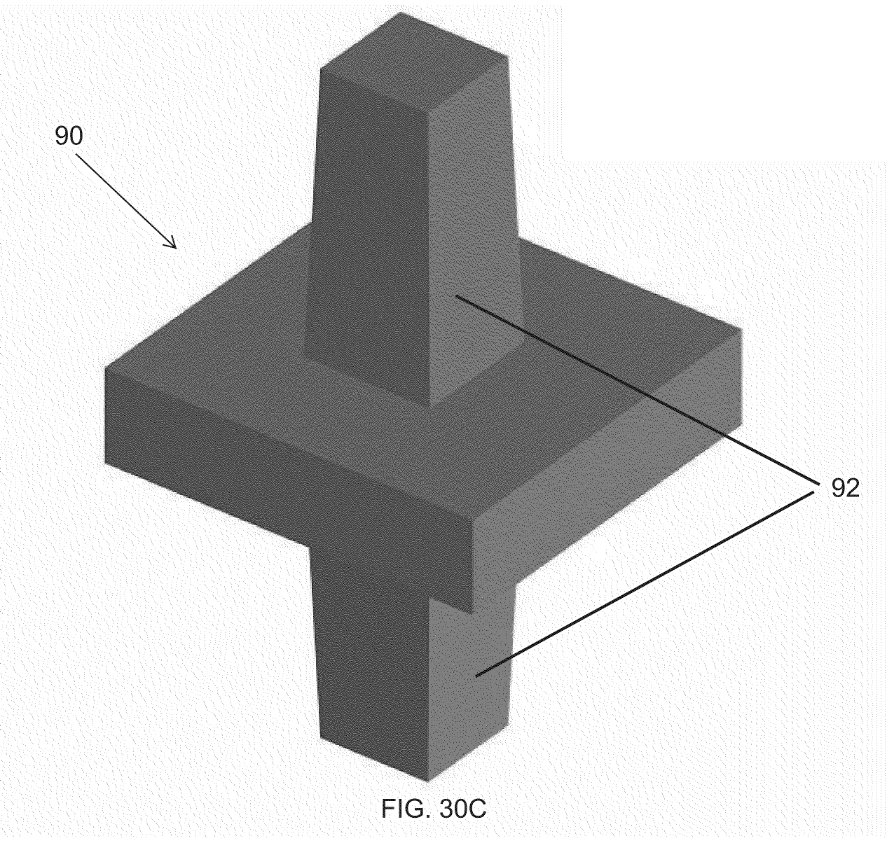

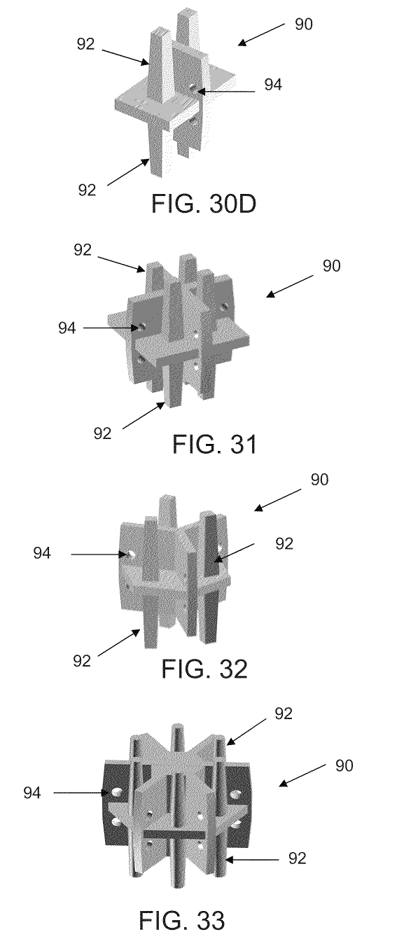

FIGS. 30-33 illustrate node modules, according to some embodiments. The node module is configured according to the number and shape of the frame structures being connected. FIG. 30A illustrates the simplest base node module, according to some embodiments. In this embodiment, the node module 90 has a single connector 92. FIG. 30B illustrates a simple node module with an opposing pair of connectors having different axes, suitable for vertex-to-vertex connection, according to some embodiments. In this embodiment, the node module 90 has a two opposing connectors 92 that are not on the same axis. FIG. 30C illustrates a simple node module with an opposing pair of connectors sharing an axis to connect cells face-to-face, according to some embodiments. In this embodiment, the node module 90 has a two opposing connectors 92 that are on the same axis. FIG. 30D illustrates a node module having at least two pair of connectors on a first plate, and a second plate having a plane that orthogonally intersect the plane of the first plate. In some embodiments, the node modules can have support plates and connectors, also referred to as “pins” herein, that are complementary with sockets, for example, found in the corners of frame structures. In FIG. 30D, for example, the node module has four pins 92, two extending upwards and two extending downwards, allowing up to four frames to be connected at a single point, in some embodiments.

FIG. 31 shows a node having 4 pair of connectors, according to some embodiments. In FIG. 31, the node module has four downward extending pins 92 and four upward extending pins 92, allowing up to eight geometrical frames to be connected at a single point, in some embodiments.

FIGS. 32 and 33 show node modules suitable for use with non-cuboid frame structures, according to some embodiments. In FIG. 32, the node module has six pins 92, three pointing upwards and three pointing downwards, allowing up to six geometrical frames to be connected at a single point, in some embodiments. In FIG. 33, the node module has twelve pins 92, six pointing upwards and six pointing downwards, allowing up to twelve geometrical frames to be connected at a single point, in some embodiments.

The node module can also comprise apertures 94 in the body of the node module, allowing the system to include other fastening means, such as bolts, rivets, and the like, in an effort to provide a stronger interconnected structure.

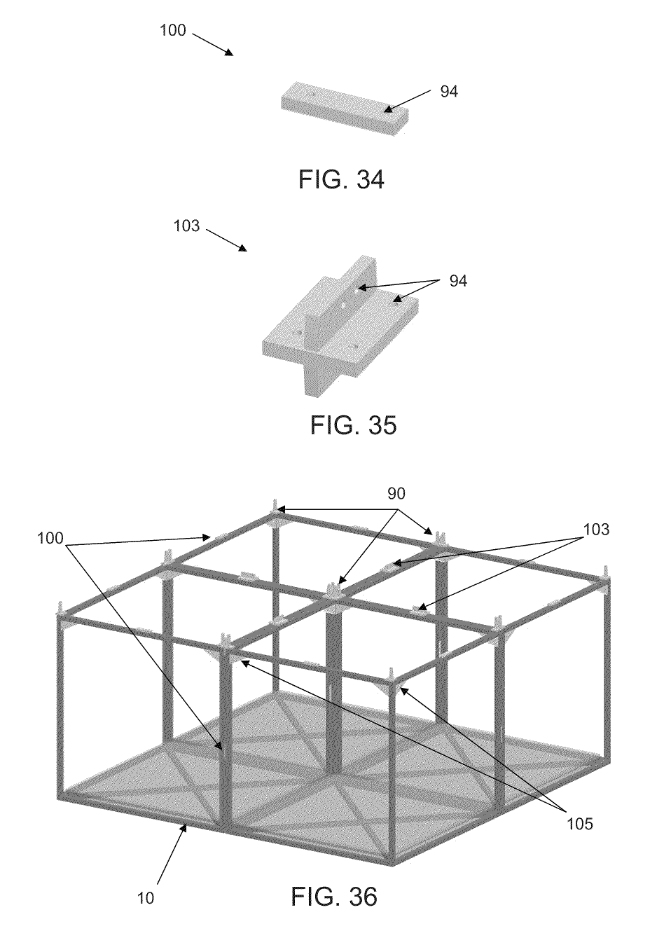

FIGS. 34 and 35 show other connection means that include the use of plates and bolts, according to some embodiments. The design of the plates 100,103 can vary to match the design of the node modules, wherein location in the building or non-building structure will be used by one of skill to determine load-bearing requirements. The plate modules can also comprise apertures 94 corresponding with apertures found in the body of the performed bars permitting two or more performed bars of different geometrical frames to be inter-connected.

FIG. 36 shows a series of interconnected cuboid frame structures, according to some embodiments. Each frame structure can be connected together with node modules 90. Cross plates 103 can be used, in some embodiments, to connect a plurality of frame structures together, and flat plates 100 can be be used to connect adjacent frame structures. Brackets 105 can be used between bars in a frame structure, in some embodiments.

The teachings are also directed to an apparatus for transporting and constructing the frame structure system. As per the teachings provided herein, the apparatus can include a container for transporting pre-selected bars used in forming the geometrical frame, a frame structure configured for receiving the pre-selected bars from the containers and holding the pre-selected bars in a desired position to define the faces of the geometrical frame, and a configuration to facilitate connecting, for example welding, the bars to form the geometrical frame structure. A building or non-building structure can comprise the frame structure system, in some embodiments.

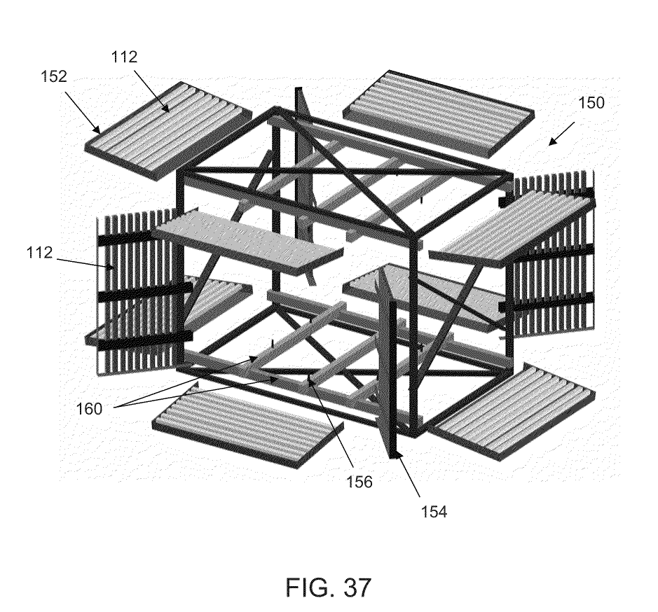

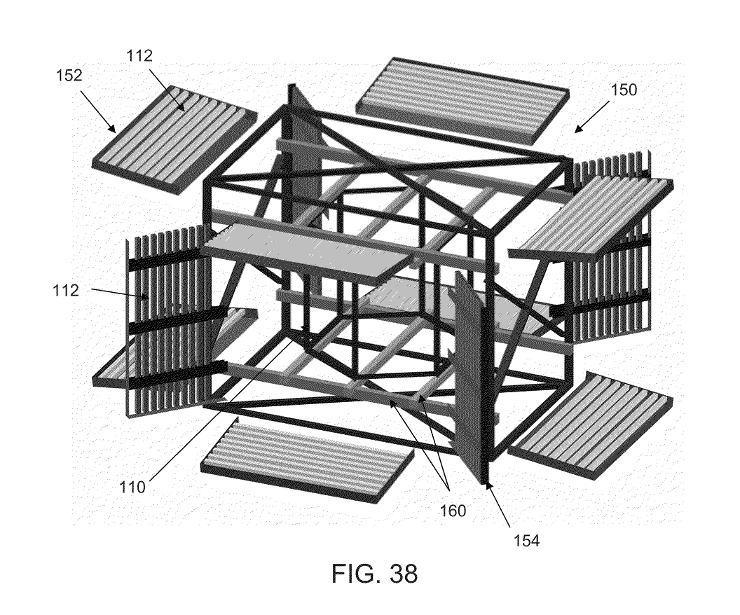

FIGS. 15 and 16 show such an apparatus, as described above. Likewise, FIGS. 37 and 38 also show an apparatus 150 for use in transporting and forming a geometrical frame structure 110. In FIG. 38, a hexagonal frame structure is being built. The apparatus 150 arranges a configuration of the pre-formed bars 112 and connects the pre-formed bars 112 to form the frame structure 110. In some embodiments, the pre-formed bars are welded together. The apparatus can be transported to site, and installed on-site. As described herein, such a machine can be transported by either land, sea, or air to the site using any transportation means known to one of skill, and the transportation can include the use of a helicopter or a crane in some embodiments. The machine can comprise containers 152,154 containing pre-formed bars 112. The containers 152, 154 can be fixed on the frame structure of the machine with connections to moveable fins 156. The frame structure can have moveable horizontal bars 160 that are able to move horizontally and vertically. The fins 156 can be located on the horizontal bars 160, which are moveable to position the fins 156 at a desired point within the machine frame structure 150. The fins 156 hold the pre-formed bars in a desired position to define the faces of the geometrical frame. The pre-formed bars 112 are installed onto fins from the pre-formed bars containers 152,154. Once the bars are installed in the structure all the bars will be connected, for example welded, to form the frame structure 110. In some embodiments, the frame structure can be easily dismantled, if required, for transporting and reinstallation at a different, or perhaps the same, construction site.

In some embodiments, the system can be designed “by-the-numbers”. The bars can be pre-cut, for example, to a standardized size or sizes and placed in numbered containers for ease of transportation to the site for assembly into the cells, where the cells can be interconnected as per design. The cells can be lifted by cranes, placed next to each other as per the design, and connected using the nodes and other connection means taught herein. One of skill will appreciate the ability to design and distribute load throughout a building or non-building structure, adding an element of simplicity and safety to the task of design and construction.

Moreover, the teachings provided herein include a computerized system that includes a processor, as well as a database operable to store data to assist in the sizing and construction of cell components for particular designs and an instruction module to instruct the system on a variety of system component configurations to align cell components as taught herein. The database and instruction module are in a non-transitory computer readable storage medium. In some embodiments, the system can include computer-aided design (CAD) or computer-aided manufacture (CAM) technology. In some embodiments, the system creates cutting lists according to pre-designed engineering specifications, where cell components are cut to desired dimensions to facilitate assembly of the cell or cells. In some embodiments, the system can provide data that assists in, for example, any additional installation considerations, such as the placement of clip modules, bracket modules, other fasteners, and the like, such as perhaps welding, which may be desired in the construction of a cell or cells.

The cells themselves are novel for a variety of reasons. As such, the teachings are also directed to a three-dimensional, load-bearing cell for use in a cellular construction system for a building or non-building structure. The cell comprises a vertical-load-bearing bar; and, a horizontal-load-bearing bar attached to the vertical-load-bearing bar. It should be appreciated that, in some embodiments, a vertical-load-bearing bar does not have to actually have a vertical axis, as the vertical load borne by the bar's axis can be a component of a total vertical load, as described herein, where the bar's axis is at an angle θ from the total vertical load. The same is true of a horizontal-load-bearing bar, as the horizontal load borne by the bar's axis can be a component of a total horizontal load, as described herein, where the bar's axis is at an angle θ from the total horizontal load.

As described herein, the load-bearing cell can be constructed on-site and, for that reason, it can have a dimension that exceeds size standards set for transporting construction materials to a construction site as compared to pre-fabricated cellular structures. In some embodiments, the size standards are established by the transportation means, and can differ between jurisdictions. Such transportation can include, for example, container ships, railroad cars, cargo planes, and semi-trailer trucks. Materials are transported in “unit load devices”, in some embodiments. Such devices are general palates and containers. The containers are sometimes referred to as cans or pods and are designated as LD1, LD2, LD3, LD4, LD6, LD7, LD8, and LD11, in some embodiments. In some embodiments, the bars in the cells can range in length from greater than 0 feet to 40 feet, from about 2 feet to about 20 feet, from about 5 feet to about 30 feet, from about 3 feet to about 12 feet, from about 5 feet to about 15 feet, from about 4 feet to about 8 feet, or any range therein. In some embodiments, the bars in the cells can have a length that is about 62, 88, 96, 125, or 238 inches, or any size therein. In some embodiments, a cell built for use in the construction of residential or commercial buildings, which may also include parking floors, for example, may be approximately 28′ L×28′ W×12′-14′ H. It should be appreciated that a cell of this size cannot be considered as transportable by normal transportation means, as described above.

The load-bearing cell can also be configured to attach to a second cell using any cell-to-cell connector means taught herein. The load-bearing cell and the second cell being can be connected through the cell-to-cell connector in a face-to-face, edge to edge, or vertex to vertex arrangement in the cellular construction of the building or non-building structure.

The load-bearing cell can be used as a shell support structure or a core support structure and, in some embodiments, can be composed of prefabricated assembly components that are readily transportable to the site. Moreover, the load-bearing cell can be more readily assembled and interconnected within the building or non-building structure when compared to non-cellular load-bearing structures that are otherwise used for the shell support structure or the core support structure of the building or non-building structure.

In some embodiments, the load-bearing cell can have an internal cross-bracing across the inner volume of the cell that functions to subdivide load-induced stresses into smaller distributed force components. And, in some embodiments, the load-bearing cell can have a vertical load-bearing bar with a fitting that is complementary to the cell-to-cell connector. In these embodiments, the cell-to-cell connector can be a single-unit node having at least one pair of connectors for connecting the load-bearing cell to the second cell.

Cell-to-cell connectors can have any of a variety of designs contemplated by one of skill, if limited to gist of the teachings provided herein. In some embodiments, the cell-to-cell connector can comprise a first plate having the at least one pair of bar connectors and a second plate forming a plane that intersects a plane formed by the first plate at an angle θ ranging from about 0 degrees to about 45 degrees. The second plate can be positioned between at least two pair of bar connectors on the first plate, each pair of bar connectors having a first connector on a first side of the first plate and a second connector on a second side of the first plate, the first side opposing the second side.

As such, in some embodiments, the angle θ can comprise an angle of incline that ranges from greater than 0 degrees to about 45 degrees upon which the building or non-building structure is constructed on a support surface. And, in some embodiments, the angle θ can comprise an angle of assembly formed by a stacking of load-bearing cells within the building or non-building structure.

The teachings are also directed to a frame structure system. The system can comprise a series of inter-connected, modular three dimensional geometrical frame structures connected in a face-to-face arrangement, each individual frame structure comprising a series of bars connected to define faces of a three dimensional geometrical frame structure that includes a base face; and, at least one bar forming a bracing for a face of the geometrical frame structure. And, the geometrical frame structure can comprise a plurality of bars that form a cross-bracing for the base face.

In some embodiments, the geometrical frame structure can comprise bars forming a triangular frame structure within a vertical face of the geometrical frame structure, the triangular frame structure positioned within the upper part of the face; one or more diagonal bars to cross-brace vertical faces of the frame; or one or more diagonal bars extending across the interior of the frame. In some embodiments, a geometrical frame structure can comprise at least 6 bars and, in some embodiments, a geometrical frame structure can comprise cuboid frame structures formed from 14 bars, having twelve bars forming the edges of the cuboid frame structure, and two bars forming a cross-bracing for a base face.

In some embodiments, the frame structure system can comprise any means for interconnecting the geometrical frame structures in a face-to-face, vertex-to-vertex, or edge-to-edge configuration, or any means for connecting a structure to a base surface. And, in some embodiments, the geometrical frame structures can be connected side-by-side and/or stacked, for example, on top of each other. In these embodiments the structures can be used to form a core support structure or a shell support structure for a building or non-building structure.

The teachings are also directed to a method of constructing the frame structure system, or cell, on-site. The method comprises delivering a plurality of pre-formed load-bearing bars to a construction site, in which each bar in the plurality of load-bearing bars can have a dimension that was preselected for forming the geometrical frame structure without further resizing of the load-bearing bar. The method also comprises forming the geometrical frame structures on-site.

The node module is a connection means that is novel in itself, and it provides a significant contribution to the art of construction. And, the node modules, or any of the variety of connection means (that is, any of the connectors) taught herein, can be made using any method known to one of skill. In some embodiments, the node modules or other connectors can be cast, for example. In some embodiments, the node modules or other connectors can be constructed from individual components that are fastened-together to create a node module. One of skill in the art will know how to select the proper materials for handling a load in a particular location in a building or non-building structure. In some embodiments, the node module or other connectors can comprise any type of steel selected by one of skill as suitable for the intended application. In some embodiments, the node modules or other connectors can include another metal alloy selected on the basis of intended use, cost, and practicality. In some embodiments, the alloy can be an aluminum alloy, titanium alloy, stainless steel, or the like. In some embodiments, the node module can comprise a synthetic material, such as a polymeric component, for example a plastic material, particularly in applications that have limited load requirements. In some embodiments, the node module or other connectors can be a natural material, such as a material comprising a ceramic or wood component. And, in some embodiments, the node module can comprise an elastic material. For example, the elastic material can serve as a coating on the node module, as a protective coating or simply as a material that provides some elasticity to the system to reduce stresses and noise that may occur from movements in the system. Such materials can be placed as a coating where the bars contact the nodes to add to seismic resistance, in some embodiments.

In some embodiments, a three-dimensional printer technology can be used for casting the node modules or other connectors. This technology is expanding rapidly and can create metal, three-dimensional units like stainless steel having complicated shapes.

In some embodiments, the node module comprises a support structure having a top surface and a bottom surface; and, a plurality of bar connectors. In these embodiments, the plurality of bar connectors can include at least one pair of bar connectors, each pair configured to direct (i) an opposing axial load into the support structure, the opposing axial load comprising a first load on the top surface that is opposed to a second load on the bottom surface; and, (ii) an opposing shear load that is orthogonal to the opposing axial load between each of the at least one pair through the support structure, the opposing shear load comprising a tensile force and a compression force on the support structure. Each bar connector is configured to mate with a respective, complementary portion of a bar, the mating of each of the bar connectors with their respective bars forming a node module configured to bear the opposing axial load and the opposing shear load within the building or non-building structure.

In some embodiments, the top surface and the opposing bottom surface of the support structure have a compressive strength that is at least as high as a highest expected axial load in a location of intended use within the building; and, the connection between each respective bar and the node module has a shear strength that is at least as high as a highest expected load that is orthogonal to the axial load in the location of intended use within the building.

The node modules taught herein can have one or more connectors for connecting the node module to a bar. In some embodiments, the node module can comprise a pair of connectors within the at least one pair of bar connectors that shares a central axis, or it can comprise a pair of connectors that do not share a central axis. The node module can be used as a component in a shell support structure or a core support structure. And, in some embodiments, the mating of each of the bar connectors with their respective bars comprises a releasable, slidable connection.

In some embodiments, the support structure comprises a horizontal base plate with at least one pair of bar connectors and a vertical plate, the vertical plate forming a plane that intersects a plane formed by the horizontal plate and separating the at least one pair of bar connectors. The node module can comprise a cast metal alloy and, in some embodiments, the node module can include an elastic coating, for example, where the node module contacts a bar.

The support structure can comprise a first plate having the at least one pair of bar connectors and a second plate forming a plane that intersects a plane formed by the first plate at an angle θ, the second plate separating the at least one pair of bar connectors. The angle θ, for example, can comprise an angle of incline upon which the building or non-building structure is constructed. In some embodiments, the angle θ can comprise an angle of assembly formed by a stacking of cellular bar modules within the building or non-building structure.

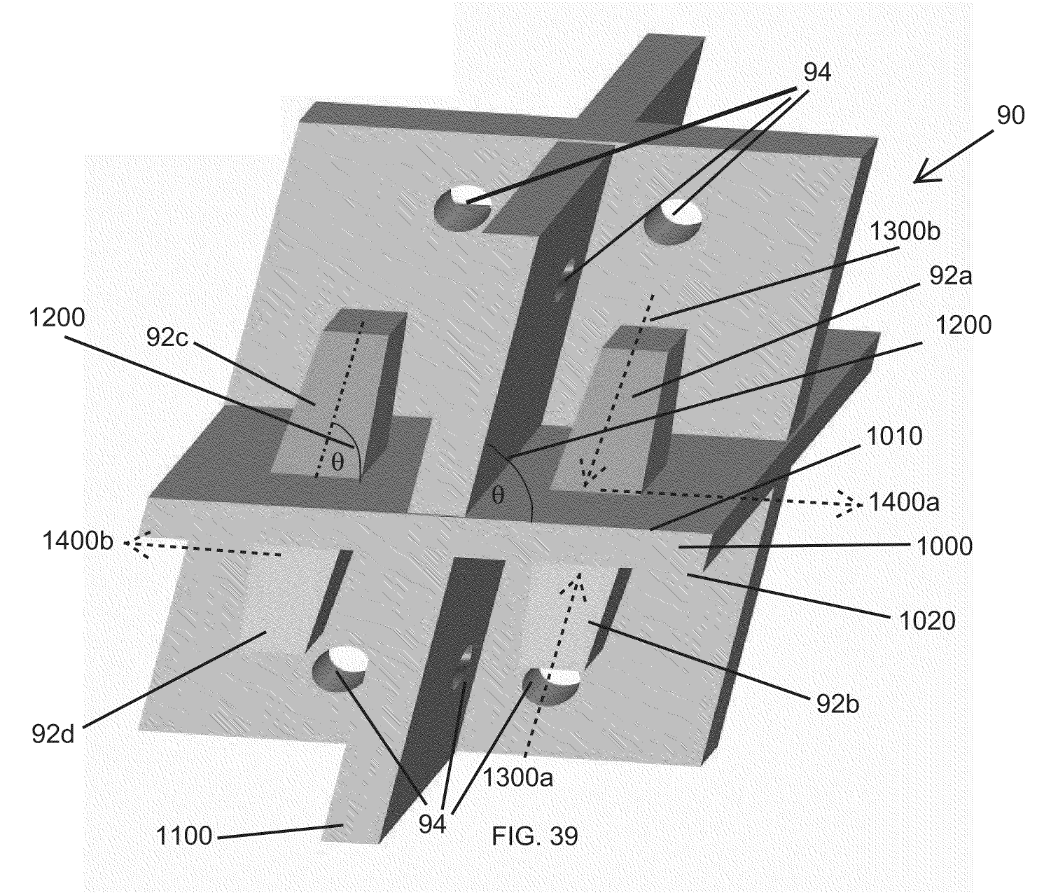

FIG. 39 illustrates a load-bearing node module which can be used as a connection means, and which can be inclined at a desired angle, according to some embodiments. As described herein, the load-bearing, node module can be used for simplifying the connection of a series of load-bearing bars during the construction of a building or non-building structure. In these embodiments, the node module 90 comprises a first plate 1000 comprising a top surface 1010, a bottom surface 1020, providing a base for a plurality of bar connectors 92. The first plate 1000 forms a first plane, and, a second plate 1100 forms a second plane that intersects the first plane at an angle θ 1200, the second plate 1100 separating the at least one pair of bar connectors 92a,92b from a second pair of bar connectors 92c,92d, where there is at least a second pair of bar connectors. The angle θ can also be present, and can even be the same angle, between the axis of a connector 92 and the first plate 1000, for example. The plurality of bar connectors can include at least one pair of bar connectors configured to direct (i) an opposing axial load 1300a,1300b into the first plate 1000, the opposing axial load 1300a,1300b comprising a first axial load 1300a on the top surface that is opposed to a second axial load 1300b on the bottom surface; and, (ii) an opposing shear load 1400a,1400b that is orthogonal to the opposing axial load 1300a,1300b between each of the at least one pair of connectors 92a,92b/92c,92d through the first plate, the opposing shear load 1400a,1400b creating a tensile force, a compression force, or a combination thereof, on the first plate 1000. As described herein, a load can include, for example, a dead load, a live load, an environmental load, or a combination thereof.

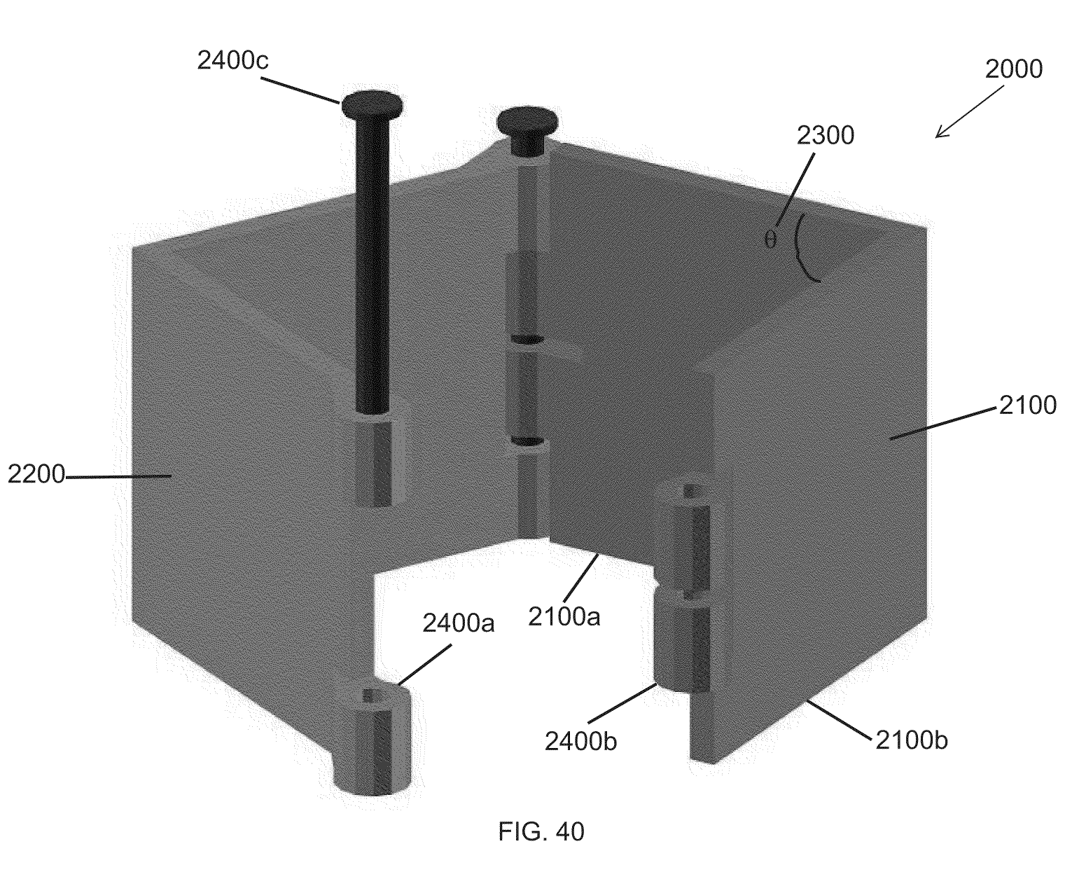

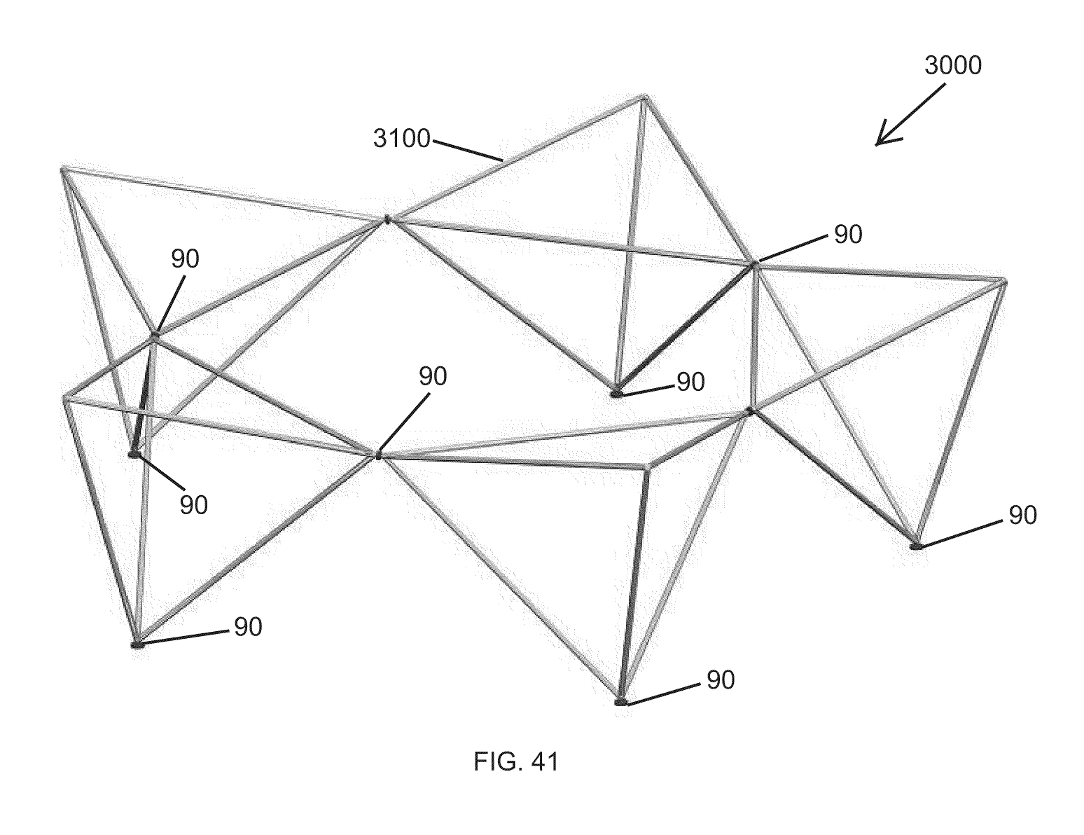

A variety of connecting means can be used with the teachings provided herein. FIG. 40 illustrates a clip module that can be used as a connection means, according to some embodiments. The clip module 2000 can be used to connect bars in the teachings provided herein. The clip module 2000 can be pre-formed as a single-unit, or it can be provided in component pieces for assembly at the site of construction. In FIG. 40, the clip module 2000 has four components, to opposing sides 2100,2200, each having an angle θ 2300 between connecting walls 2100a,2100b, and each having a complementary mating means 2400a,2400b,2400c. The complementary mating means 2400a,2400b,2400c is a hinge/pin connection in FIG. 40, but one of skill will appreciate that any mating or fastening means will work, in some embodiments. In some embodiments, the clip module 2000 can have any number of components, as long as the components can attached to form a structural connector. In some embodiments, all of the component walls on the clip module 2000 can be planar, have a single angle θ, have a plurality of angles θᵢ, or a combination thereof. One of skill will appreciate that the clip module 2000 can be designed to fit the design of the bars being connected and can be a single-unit or multi-component design.

Each bar connector can be configured to mate with a respective, complementary portion of a bar, the mating of each of the bar connectors with their respective bars through the node module configured to bear an axial load and a shear load orthogonal to the axial load within the building. One of skill can calculate the expected loads and acceptable risk factors to use as a multiple in the design and engineering of a building or non-building structure, for example. The mating can comprise a releasable, slidable connection, the top surface and the opposing bottom surface of the support structure can have a compressive strength that is at least as high as a highest expected axial load in a location of intended use within the building; and, the connection between each respective bar and the node module can have a shear strength that is at least as high as a highest expected shear load orthogonal to the axial load in the location of intended use within the building.

The teachings provided herein offers considerable flexibility and ease of assembly of any of a variety of structures, virtually any structure reasonably contemplated by one of skill. FIG. 41 illustrates a node-to-node arrangement that includes a series of interconnected triangular prisms, according to some embodiments. Node modules 90 can be custom-designed and produced to connect this triangular prism arrangement 3000 or virtually any reasonable bar 3100 arrangement design contemplated by one of skill.

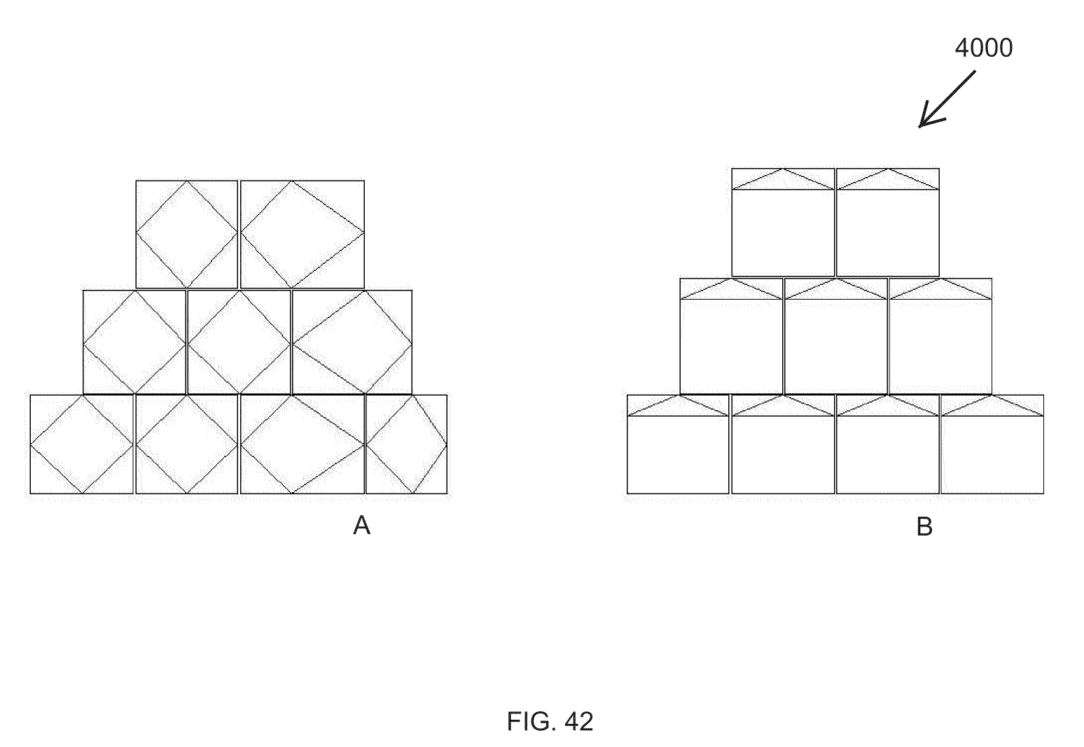

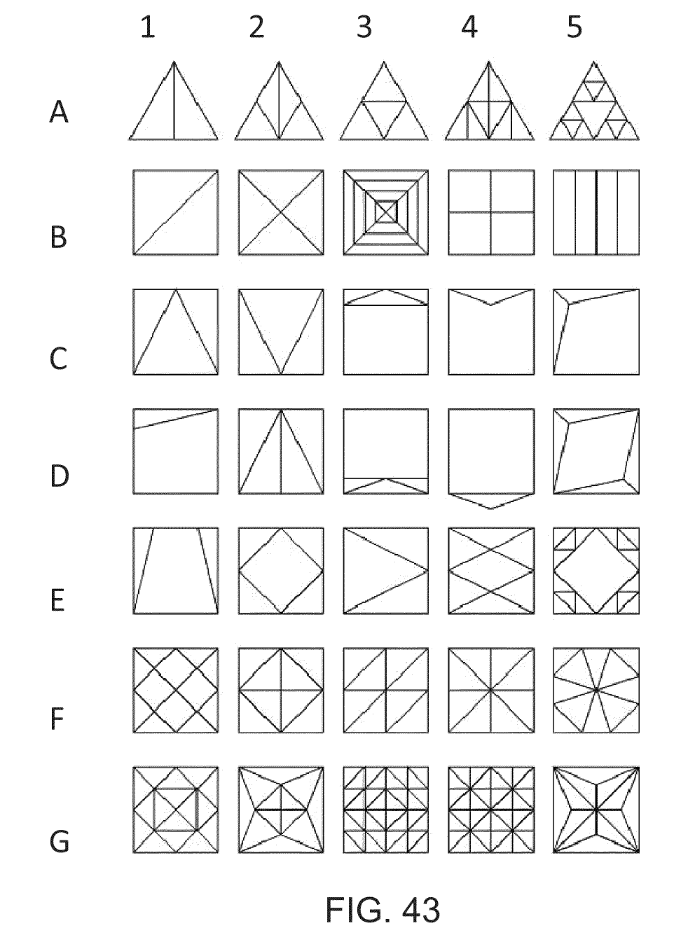

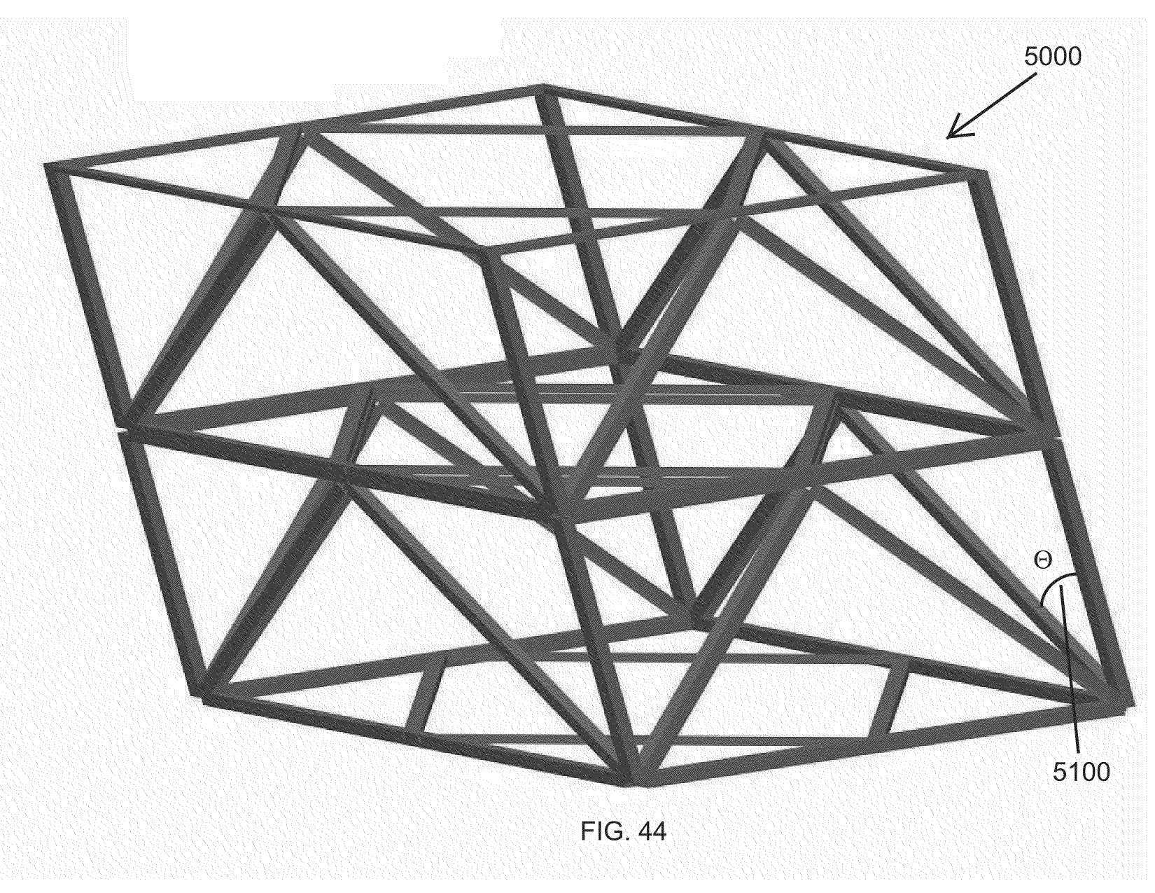

FIG. 42 illustrates the flexibility in interconnecting and stacking that is provided herein, according to some embodiments. The structural frames can be built and interconnected corner-to-corner, as described herein, but FIG. 42 shows that they can also be connected horizontally and vertically between the corner of a cell to a corner of a bracing bar, for example. FIGS. 42A and 42B show top and side cross-sectional views of an example structure 4000 interconnected with node modules, and perhaps clip modules, plates, fasteners, or other connection means (not shown) in this manner. And, FIGS. 43A₁₋₅-G₁₋₅ provide a variety of bracing designs contemplated, according to some embodiments.

FIG. 44 illustrates an example of a cell that is built as an inclined cell, where the node module has an angle θ greater than 0, according to some embodiments. The inclined cell 5000 can include an incline built into the node modules (not shown), where at least one type of node module in the structure can, for example, include the angle θ 5100 between a connector and a plate supporting the connector, as described herein. The inclined cell 5000 can have additional bracing, as shown, for horizontal and inclined faces. The bracing can be suitable, for example, in the core of a building or non-building structure. In some embodiments, an opening can be added throughout the system to assist in air circulation in the completed structure.

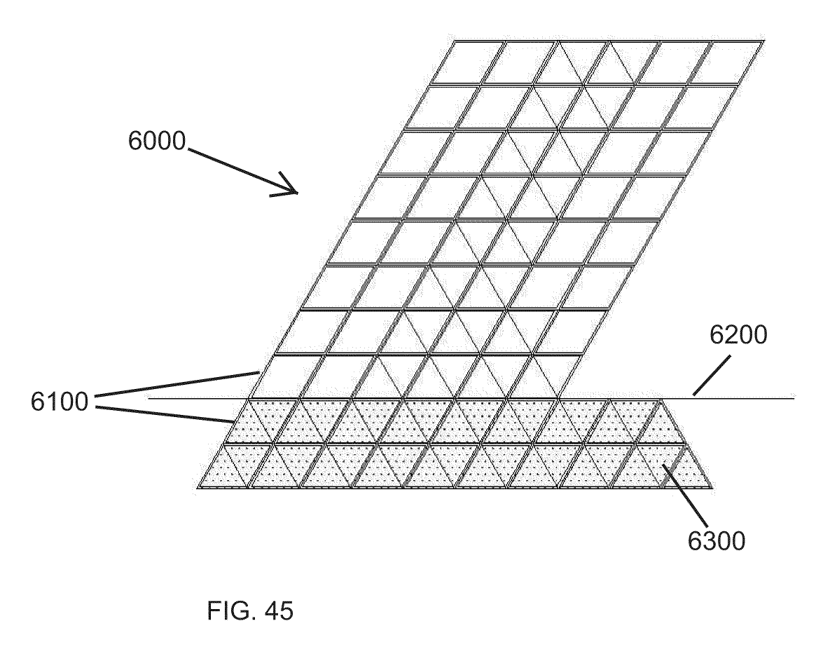

FIG. 45 illustrates a side-aspect sketch of an inclined building structure, where the structure includes inclined cells and inclined node modules, according to some embodiments. It should be appreciated that in this or other embodiments, the cells 6100 can be used at, or below, ground level 6200 in the foundation of a building or non-building structure 6000. The below-ground cells 6100 can, in some embodiments, be filled with a suitable foundational material 6300, such as concrete, compact soil, or any other material used by one of skill as a foundational material, which can include, for example, an excavated soil with a special treatment to provide a sustainable solution. In some embodiments, the compacted soil can be from the excavated soil from the same or nearby plot, for example, having a suitable soil treatment known to one of skill that would make it functional for use as a foundational material.

The teachings are, of course, also directed to a cellular construction system for constructing a building or non-building structure. The structures can be modular or non-modular. The system can comprise a node module as described herein; a first cell having a first three-dimensional frame structure comprising a first axial load bearing bar having a first respective complementary portion for mating with a first connector of the node module; and, a second cell having a second three-dimensional frame structure comprising a second axial load bearing bar having a second respective complementary portion for mating with a second connector of the node module. The node module can connect the first three-dimensional frame structure to the second three-dimensional frame structure in the creation of a cellular building structure or a cellular non-building structure.

The term “modular” can include, for example, pre-fabricated cells that are transported to the site as modules, or the cells fabricated on-site, in each case useful as transportable modules, either to the site or within a site. Due to this flexibility, the dimensions of the first or second cellular, three-dimensional frame structure can exceed size standards set for transporting construction materials to a construction site as compared to pre-fabricated cellular structures that are required to follow the size standards that are set by practicality and/or the policies or law of the jurisdiction at which the building or non-building structure is being constructed.

As per the teachings provided, it should be appreciated that the node module connects the first three-dimensional geometrical frame structure to the second three-dimensional geometrical frame structure in a variety of arrangements. Such arrangements include, but are not limited to, a face-to-face, edge-to-edge, or vertex-to-vertex arrangement in the creation of a cellular building structure.

It should be appreciated that any “façade treatment” can be fixed on the building structure as a lightweight element on the frame structures, in some embodiments. Moreover, the system can be constructed using the methods taught herein to provide high-seismic-resistant building or non-building structure. The gaps between the cells can be treated as expansion or seismic joints, in some embodiments.

The teachings are also directed to a method of creating the cellular building structure itself, as such buildings are also, per se, novel when constructed using the teachings provided herein. The method can comprise obtaining a node module described herein, constructing a first cell having a first three-dimensional frame structure comprising a first axial load bearing bar having a first respective complementary portion for mating with a first connector of the node module, constructing a second cell having a second three-dimensional frame structure comprising a second axial load bearing bar having a second respective complementary portion for mating with a second connector of the node module, and interconnecting the first three-dimensional geometrical frame structure to the second three-dimensional geometrical frame structure using the node module in the creation of the cellular building structure. The interconnecting can include (i) mating the first connector of the node module to the first respective complementary portion and (ii) mating the second connector of the node module to the second respective complementary portion.

The teachings are also directed to a cellular construction system comprising a single-unit, node module. The single-unit, node module can be configured with a means for interconnecting a series of structural, three-dimensional load-bearing cells, the series including a first cell and a second cell. The first cell can comprise a first axial load bearing bar having a first respective complementary portion for mating with a first connector of the node module. The second cell can comprise a second axial load bearing bar having a second respective complementary portion for mating with a second connector of the node module. The node module can connect the first cell to the second cell using a process that includes (i) mating the first connector of the node module to the first respective complementary portion and (ii) mating the second connector of the node module to the second respective complementary portion, such that the first cell and the second cell are connected in a face-to-face, edge to edge, or vertex to vertex arrangement in the creation of a cellular building or non-building structure.

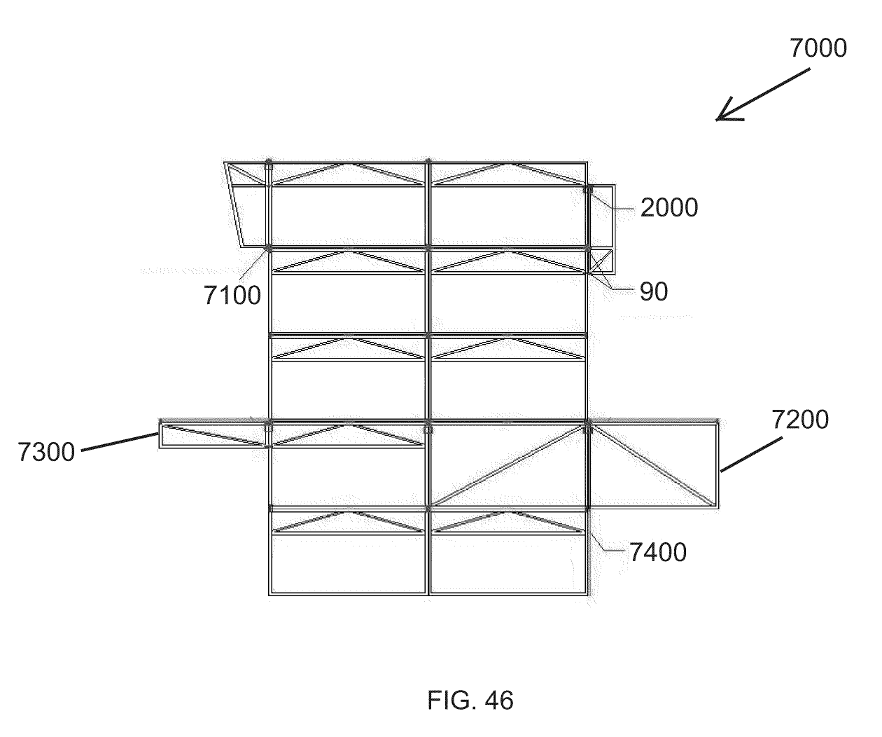

FIG. 46 illustrates the construction of a building or non-building structure having the cells as cantilever units, according to some embodiments. The cantilevered structure 7000 uses a combination of node modules 90, clip modules 2000, bracket modules 7100, cantilevered cells 7200,7300, and other 1-dimensional (linear or non-linear), or 2-dimensional load bearing units fabricated using the methods taught herein, to help carry the additional loads provided by the cantilevered cells.

In embodiments taught herein, cross-bracing can be used for extra support. And, it should be appreciated that bracing can include the use of cables to provide a tension-based bracing through the tensile strength of the cable alone, rather than the tensile and compression strength of an otherwise rigid bracing. Cables can be used, for example, both internally and externally with the cells.

Moreover, slabs can be introduced in the cells. Such slab systems can be cast in situ, for example, by adding cross bracing and inverted pyramid bracing which can be filled with concrete after adding a suitable shutter. In some embodiments, such slab systems can simply be adding suitable bracing to the base face of the cell and cast in situ between these bars after placing the cell on flat surface. In addition, the bars at the base face and bracing bars can also have holes to allow the concrete to fill voids inside the bars to provide an additional and strong, composite effect. In some embodiments, the slab systems can be created without a need for shuttering using a process that includes (i) adding suitable bracing to the base face of the cell; (ii) placing the cell on a flat surface; and, (iii) casting lightweight concrete in situ between the bars with a suitable steel mesh reinforcement without the need for shuttering.

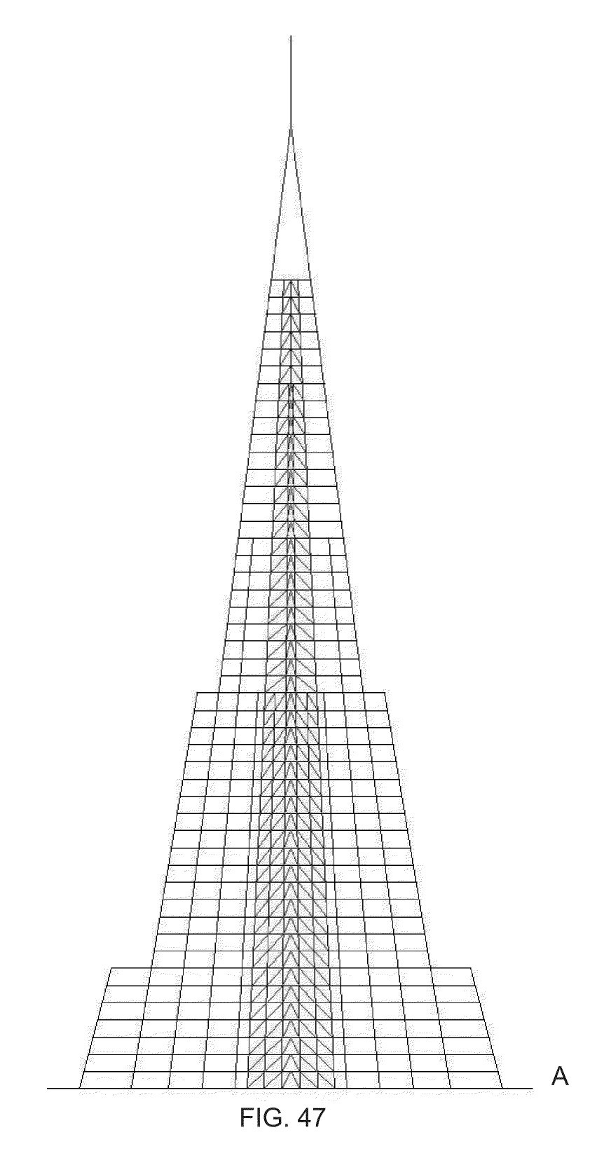

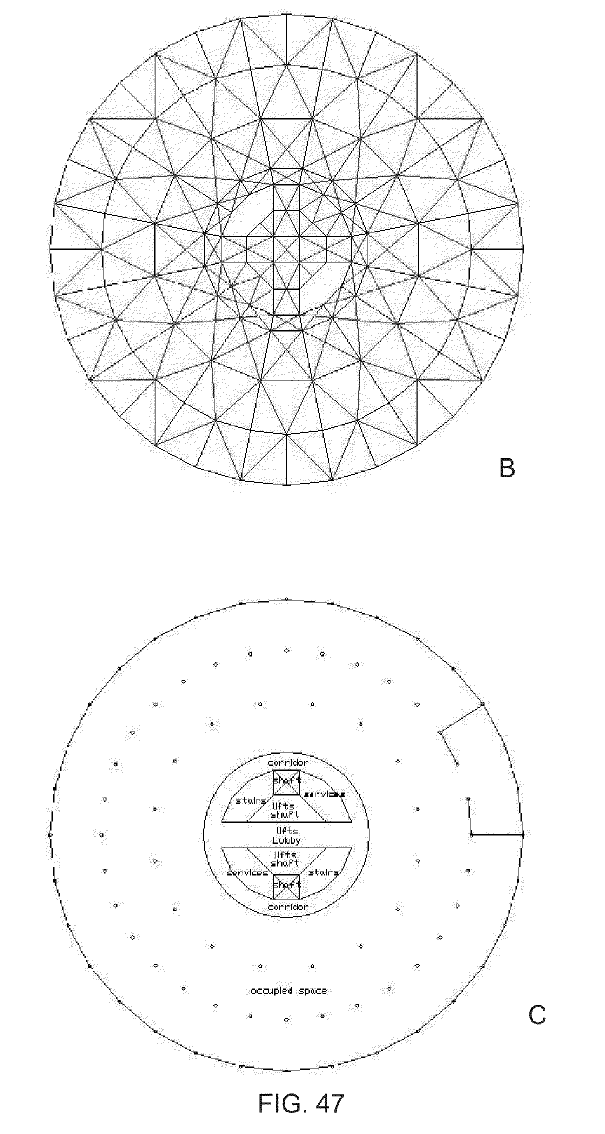

As described herein, the system can be non-modular. FIG. 47 illustrates cells placed in face-to-face arrangements and stacked in an axial/radial grid-type configuration, according to some embodiments. FIG. 47A shows a side-view of the overall structure, and FIGS. 47B-47C show a structural geometrical framing plan and an architectural zoning plan for the same structure, where the design provides a novel way to gain architectural open space within the structure.

While various exemplary embodiments have been described, those skilled in the art will realize that there are many alterations, modifications, permutations, additions, combinations, and equivalents which fall within the true spirit and scope of the teachings. It is therefore intended that the preceding descriptions not be read by way of limitation but, rather, as examples with the broader scope of the concepts disclosed herein.

We claim:

1. A load-bearing, node module for simplifying the connection of a series of load-bearing bars during the construction of a building or non-building structure, the node module comprising:
a support structure having a top surface and a bottom surface; and,
a plurality of bar connectors, the plurality including at least one pair of bar connectors, each pair configured to direct (i) an opposing axial load into the support structure, the opposing axial load comprising a first load on the top surface that is opposed to a second load on the bottom surface; and, (ii) an opposing shear load that is orthogonal to the opposing axial load between each of the at least one pair through the support structure, the opposing shear load comprising a tensile force and a compression force on the support structure;
wherein,
each bar connector is configured to mate with a respective, complementary portion of a bar, the mating of each of the bar connectors with their respective bars forming a node module configured to bear the opposing axial load and the opposing shear load within the building or non-building structure;
the top surface and the opposing bottom surface of the support structure have a compressive strength that is at least as high as a highest expected axial load in a location of intended use within the building; and,
the connection between each respective bar and the node module has a shear strength that is at least as high as the highest expected load orthogonal to the axial load in the location of intended use within the building.

2. The node module of claim 1, wherein the node module comprises a pair of connectors within the at least one pair of bar connectors that shares a central axis.

3. The node module of claim 1, wherein the node module is used as a component in a shell support structure.

4. The node module of claim 1, wherein the node module is used as a component in a core support structure.

5. The node module of claim 1, wherein the mating comprises a releasable, slidable connection.

6. The node module of claim 1, wherein the support structure comprises a horizontal base plate with at least one pair of bar connectors and a vertical plate, the vertical plate forming a plane that intersects a plane formed by the horizontal plate and separating the at least one pair of bar connectors.

7. The node module of claim 1, wherein the node module comprises a cast metal alloy.

8. The node module of claim 1, the node module further comprising an elastic coating where the node module contacts a bar.

9. The node module of claim 1, wherein the support structure comprises a first plate having the at least one pair of bar connectors and a second plate forming a plane that intersects a plane formed by the first plate at an angle θ, the second plate separating the at least one pair of bar connectors.

10. The node module of claim 9, wherein the angle θ comprises an angle of incline upon which the building or non-building structure is constructed.

11. The node module of claim 9, wherein the angle θ comprises an angle of assembly formed by a stacking of cellular bar modules within the building or non-building structure.

12. A system comprising at least two vertical load-bearing bars and the node module of claim 1.

13. A load-bearing, node module for simplifying the connection of a series of load-bearing bars during the construction of a building or non-building structure, the node module comprising:
a first plate comprising a top surface, a bottom surface, providing a base for a plurality of bar connectors, the first plate forming a first plane; and,
a second plate forming a second plane that intersects the first plane at an angle θ, the second plate separating the at least one pair of bar connectors;
wherein,
the plurality of bar connectors includes at least one pair of bar connectors configured to direct (i) an opposing axial load into the first plate, the opposing axial load comprising a first axial load on the top surface that is opposed to a second axial load on the bottom surface; and, (ii) an opposing shear load that is orthogonal to the opposing axial load between each of the at least one pair of connectors through the first plate, the opposing shear load comprising a tensile force and a compression force on the first plate;
each bar connector is configured to mate with a respective, complementary portion of a bar, the mating of each of the bar connectors with their respective bars through the node module configured to bear a vertical load and a horizontal load within the building;
the mating comprises a releasable, slidable connection;
the top surface and the opposing bottom surface of the support structure have a compressive strength that is at least as high as a highest expected axial load in a location of intended use within the building; and,
the connection between each respective bar and the node module has a shear strength that is at least as high as a highest expected shear load orthogonal to the highest expected axial load in the location of intended use within the building.

14. The node module of claim 13, wherein the connectors within the at least one pair of bar connectors shares a central axis.

15. The node module of claim 13, wherein the node module is used as a component in a shell support structure.

16. The node module of claim 13, wherein the node module is used as a component in a core support structure.

17. The node module of claim 1, wherein the node module comprises a cast metal alloy.

18. The node module of claim 1, the node module further comprising an elastic coating where the node module contacts a bar.

19. A system comprising at least two load-bearing bars and the node module of claim 9.

20. A cellular construction system for constructing a building or non-building structure, comprising:
the node module of claim 1;
a first cell having a first three-dimensional frame structure comprising a axial load bearing bar having a first respective complementary portion for mating with a first connector of the node module; and,
a second cell having a second three-dimensional frame structure comprising a second axial load bearing bar having a second respective complementary portion for mating with a second connector of the node module;
wherein, the node module connects the first three-dimensional frame structure to the second three-dimensional frame structure in the creation of a cellular building structure or a cellular non-building structure.

21. The system of claim 20, wherein the dimensions of the first or second cellular, three-dimensional frame structure exceeds size standards set for transporting construction materials to a construction site as compared to pre-fabricated cellular structures that are required to follow the size standards.

22. The system of claim 20, wherein the node module connects the first three-dimensional geometrical frame structure to the second three-dimensional geometrical frame structure in a face-to-face, edge-to-edge, or vertex-to-vertex arrangement in the creation of a cellular building structure.

23. A cellular construction system, comprising:
the node module of claim 9;
a first cell having a first three-dimensional frame structure comprising a first axial load bearing bar having a first respective complementary portion for mating with a first connector of the node module; and,
a second cell having a second three-dimensional frame structure comprising a second axial load bearing bar having a second respective complementary portion for mating with a second connector of the node module;
wherein,
the node module connects the first three-dimensional geometrical frame structure to the second three-dimensional geometrical frame structure in the creation of a cellular building or non-building structure.

24. The system of claim 23, wherein the first or second cellular, three-dimensional frame structure exceeds size standards set for transporting construction materials to a construction site as compared to pre-fabricated cellular structures that are required to follow the size standards.

25. The system of claim 23, wherein the node module connects the first three-dimensional geometrical frame structure to the second three-dimensional geometrical frame structure in a face-to-face, edge-to-edge, or vertex-to-vertex arrangement in the creation of a cellular building structure.

26. A method of creating a cellular building structure, comprising:
obtaining the node module of claim 1;
constructing a first cell having a first three-dimensional frame structure comprising a first axial load bearing bar having a first respective complementary portion for mating with a first connector of the node module;
constructing a second cell having a second three-dimensional frame structure comprising a second axial load bearing bar having a second respective complementary portion for mating with a second connector of the node module; and,
interconnecting the first three-dimensional geometrical frame structure to the second three-dimensional geometrical frame structure using the node module in the creation of the cellular building structure;
wherein, the interconnecting includes (i) mating the first connector of the node module to the first respective complementary portion and (ii) mating the second connector of the node module to the second respective complementary portion.

27. A method of creating a cellular building structure, comprising:
obtaining the node module of claim 9;
constructing a first cell having a first three-dimensional frame structure comprising a first axial load bearing bar having a first respective complementary portion for mating with a first connector of the node module;
constructing a second cell having a second three-dimensional frame structure comprising a second axial load bearing bar having a second respective complementary portion for mating with a second connector of the node module; and,
interconnecting the first three-dimensional geometrical frame structure to the second three-dimensional geometrical frame structure using the node module in the creation of the cellular building structure;
wherein, the interconnecting includes (i) mating the first connector of the node module to the first respective complementary portion and (ii) mating the second connector of the node module to the second respective complementary portion.

28. A cellular construction system, comprising:
A single-unit, node module configured with a means for interconnecting a series of structural, three-dimensional load-bearing cells, the series including a first cell and a second cell;
the first cell comprising a first axial load bearing bar having a first respective complementary portion for mating with a first connector of the node module;
the second cell comprising a second axial load bearing bar having a second respective complementary portion for mating with a second connector of the node module;
wherein,
the node module connects the first cell to the second cell using a process that includes (i) mating the first connector of the node module to the first respective complementary portion and (ii) mating the second connector of the node module to the second respective complementary portion, such that the first cell and the second cell are connected in a face-to-face, edge to edge, or vertex to vertex arrangement in the creation of a cellular building or non-building structure.
